(19) United States
(12) Patent Application Publication
(10) Pub. No.: US 2024/0213616 A1
(43) Pub. Date: Jun. 27, 2024

(54) BATTERY AND ELECTRONIC DEVICE INCLUDING SAME

(71) Applicant: Samsung Electronics Co., Ltd., Suwon-si (KR)

(72) Inventors: Gisoo LIM, Suwon-si (KR); Jongmoon YOON, Suwon-si (KR); Gilho KIM, Suwon-si (KR); Juho SONG, Suwon-si (KR); Kwanghoon CHOI, Suwon-si (KR); Changryong HEO, Suwon-si (KR)

(21) Appl. No.: 18/594,544

(22) Filed: Mar. 4, 2024

Related U.S. Application Data
(63) Continuation of application No. PCT/KR2022/013423, filed on Sep. 7, 2022.

(30) Foreign Application Priority Data
Sep. 7, 2021 (KR) 10-2021-0119305
Dec. 8, 2021 (KR) 10-2021-0174790

(51) Int. Cl. H01M 50/358; H01M 50/183

(52) U.S. Cl. CPC H01M 50/358; H01M 50/183; H01M 2220/30

(57) ABSTRACT

According to various embodiments of the present disclosure, an electronic device may comprise: a housing and a battery disposed in the housing. The battery may comprise: a sealing member comprising a sealing material having top and bottom surfaces which are open; a first exterior member comprising a cap coupled to the sealing member and configured to cover the top surface of the sealing member; a second exterior member comprising a cap coupled to the sealing member and configured to cover the bottom surface of the sealing member; an electrode assembly including at least one electrode accommodated in the second exterior member; an electrolyte provided in the second exterior member; and a vent structure including at least one vent formed on at least one among an edge region of the sealing member, an edge region of the first exterior member, and an edge region of the second exterior member, the vent structure configured to make the inside and outside of the battery communicate with each other.

### CROSS-REFERENCE TO RELATED APPLICATIONS

This application is a continuation of International Application No. PCT/KR2022/013423 designating the United States, filed on Sep. 7, 2022, in the Korean Intellectual Property Receiving Office and claiming priority to Korean Patent Application Nos. 10-2021-0119305, filed on Sep. 7, 2021, and 10-2021-0174790, filed on Dec. 8, 2021, in the Korean Intellectual Property Office, the disclosures of each of which are incorporated by reference herein in their entireties.

### BACKGROUND

### Field

The disclosure relates to an electronic device, for example, a battery and an electronic device including the same.

### Description of Related Art

At least one component related to sound effects may be disposed in an electronic device, which may correspond to, for example, a speaker. This component may have various forms and arrangement structures inside a housing of the electronic device, depending on arrangement relationships with other components such as a battery and/or various exterior designs of the electronic device. Electronic devices including speakers may include, for example, a wearable electronic device wearable close to a user's ears, such as wireless earphones or hearing aids. In such a wearable electronic device, a microphone may be additionally placed inside a housing to perform an active noise cancellation (ANC) function.

The wearable electronic device including a speaker may be used in connection to another electronic device. Accordingly, the wearable electronic device may include an antenna for performing wireless communication with the external electronic device, and the antenna may be used to implement true wireless stereo (TWS) technology for improving the sound quality of wireless earphones, such as the ANC function, as well as for achieving all levels of comfort for the user. To implement the TWS technology, the wearable electronic device may be provided with a battery with a larger capacity and higher energy density.

For a smaller electronic device, a cylindrical battery or a coin-type battery may be available for power supply. The use of the coin-type battery may increase the design freedom of an electronic device and meet the miniaturization/compactness requirements for the electronic device in that the coin-type battery may be manufactured to have a significantly smaller volume than the cylindrical battery.

An electronic device (or a wearable electronic device) may include a battery that may supply power to electrical components in the electronic device. A coin-type battery may include exterior members such as a can and a cup that are coupled to each other, a gasket that seals between the exterior members, an electrode assembly in a jelly-roll or stack structure, and an electrolyte injected into the battery. During use, the coin-type battery may develop gas within it as the electrolyte vaporizes, and when the internal pressure of the coin-type battery continues to increase, the exterior members may be separated and/or dislodge from the gasket. Since there is a risk that the electronic device with the coin-type battery may be damaged or that electrical components inside the electronic device may ignite, it is necessary to provide a means to prevent and/or reduce the internal pressure of the coin-type battery from increasing.

### SUMMARY

Embodiments of the disclosure may provide a battery and an electronic device including the same, which may vent gas generated inside the battery to the outside of the battery through a vent structure.

However, the problems addressed in the disclosure are not limited to the above-mentioned problems, and various other problems may be determined without departing from the spirit and scope of the disclosure.

According to various example embodiments of the disclosure, an electronic device includes: a housing; and a battery disposed inside the housing. The battery includes: a sealing member comprising a sealing material and having open top and bottom surfaces; a first exterior member comprising a cap coupled to the sealing member to cover the top surface of the sealing member; a second exterior member comprising a cap coupled to the sealing member to cover the bottom surface of the sealing member; an electrode assembly accommodated in the second exterior member; an electrolyte injected into the second exterior member; and a vent structure including a vent formed in at least one of an edge region of the sealing member, an edge region of the first exterior member, and/or an edge region of the second exterior member, and configured to communicate between an inside and an outside of the battery.

According to various example embodiments of the disclosure, a wearable electronic device includes: a housing including a protrusion; and a battery disposed inside the housing. The battery includes: a sealing member comprising a sealing material and having open top and bottom surfaces; a first exterior member comprising a cap coupled to the sealing member to cover the top surface of the sealing member; a second exterior member comprising a cap coupled to the sealing member to cover the bottom surface of the sealing member; an electrode assembly accommodated in the second exterior member; an electrolyte injected into the second exterior member; and a vent structure including a vent formed in at least one of an edge region of the sealing member, an edge region of the first exterior member, and/or an edge region of the second exterior member, and configured to communicate between an inside and an outside of the battery.

According to various example embodiments of the disclosure, a battery includes: a sealing member comprising a sealing material having open top and bottom surfaces, and including an inner diameter portion, an outer diameter portion having a diameter greater than a diameter of the inner diameter portion, and a connecting portion connecting a top of the inner diameter portion to a top of the outer diameter portion; a first exterior member comprising a cap coupled to the sealing member to cover the top surface of the sealing member, and including a first planar portion and a first diameter portion extending from an edge of the first planar portion to surround at least a part of the outer diameter portion; a second exterior member comprising a cap coupled to the sealing member to cover the bottom surface of the sealing member, and including a second planar portion and a second diameter portion extending from an edge of the second diameter portion to be located between the inner diameter portion and the outer diameter portion; an electrode assembly accommodated in the second exterior member and including a first electrode tab electrically connected to the first exterior member and a second electrode tab electrically connected to the second exterior member; an electrolyte injected into the second exterior member; and a vent structure including a vent formed in at least one of a top edge region of the sealing member, a bottom edge region of the first exterior member, and/or a top edge region of the second exterior member, and configured to communicate between an inside and an outside of the battery.

A battery according to various example embodiments of the disclosure may restrict a first exterior member and/or a second exterior member from being separated from a sealing member by venting gas inside the battery to the outside of the battery through a vent structure.

According to various example embodiments of the disclosure, increased durability of a battery may restrict breakage of the battery and an electronic device including the same.

According to various example embodiments of the disclosure, increased durability of a battery may restrict ignition of electrical components in the battery and/or an electronic device including the same.

According to various example embodiments of the disclosure, since no separate components are provided for venting gas inside a battery, the battery may be miniaturized in size and/or shape, thereby making the battery compatible with a variety of electronic devices.

The effects to be obtained from the disclosure are not limited to those mentioned above, and other effects not mentioned will be apparent to those skilled in the art from the following description.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example configuration of an audio module according to various embodiments;

FIG. 3 is a diagram illustrating a side view of an electronic device according to various embodiments;

FIG. 4A is a diagram illustrating a side view of an electronic device without a first housing according to various embodiments;

FIG. 4B is a diagram illustrating a top view of an electronic device without a first housing according to various embodiments;

FIG. 5 is a perspective view illustrating a cut portion of an electronic device without a first housing according to various embodiments;

FIG. 6A is an exploded perspective view illustrating a battery according to various embodiments;

FIG. 6B is a cross-sectional view illustrating a battery according to various embodiments;

FIG. 7 is a perspective view illustrating a battery according to various embodiments;

FIG. 8A is a cross-sectional view illustrating an assembled battery according to various embodiments;

FIG. 8B is a cross-sectional view illustrating gas venting from a battery according to various embodiments;

FIG. 9 is an exploded perspective view illustrating a battery with a first exterior member separated therein according to various embodiments;

FIG. 10A is a cross-sectional view illustrating an assembled battery according to various embodiments;

FIG. 10B is a cross-sectional view illustrating gas venting from a battery according to various embodiments;

FIG. 11 is an exploded perspective view illustrating a battery according to various embodiments;

FIG. 12A is a cross-sectional view illustrating an assembled battery according to various embodiments;

FIG. 12B is a cross-sectional view illustrating gas venting from a battery according to various embodiments;

FIG. 13 is a partial cross-sectional perspective view illustrating a protrusion member formed on a first exterior member according to various embodiments;

FIG. 14 is an exploded perspective view illustrating a battery according to various embodiments;

FIG. 15A is a cross-sectional perspective view illustrating gas venting from a battery via a first through hole according to various embodiments; and

FIG. 15B is a cross-sectional perspective view illustrating gas venting from a battery via a first through hole and/or a vent structure according to various embodiments.

### DETAILED DESCRIPTION

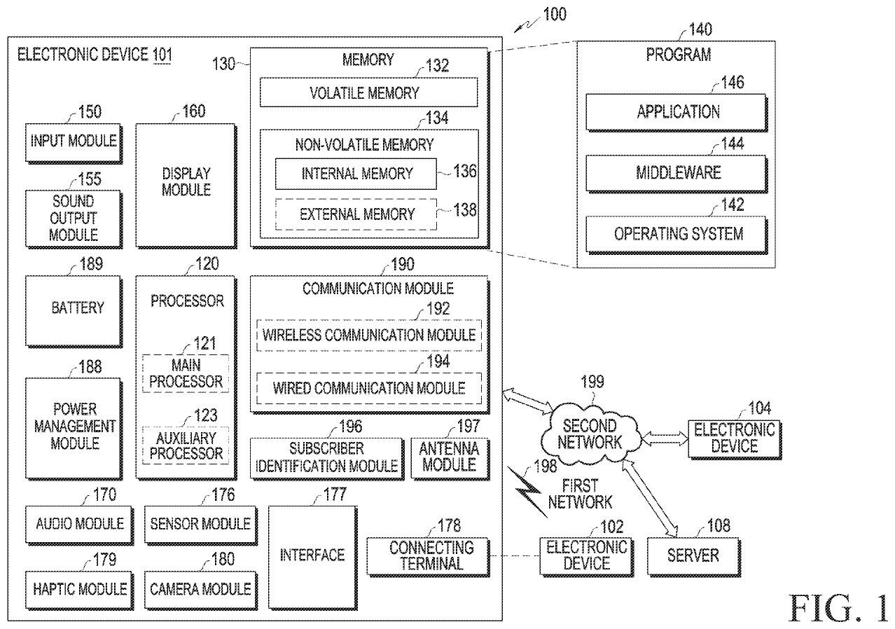

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

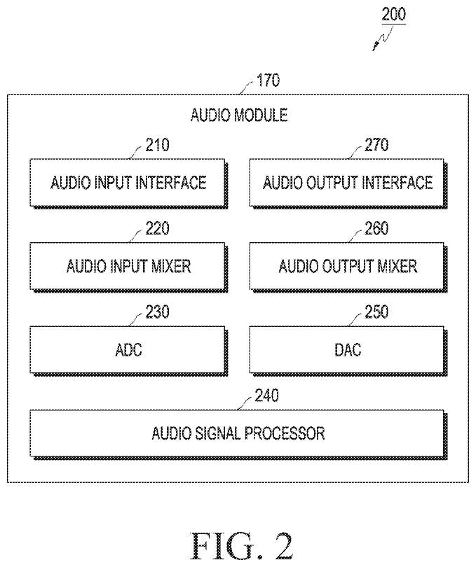

FIG. 2 is a block diagram 200 illustrating an example configuration of an audio module 170 (e.g., the audio module 170 in FIG. 1) according to various embodiments.

Referring to FIG. 2, the audio module 170 may include an audio input interface (e.g., including circuitry) 210, an audio input mixer 220, an analog-to-digital converter (ADC) 230, an audio signal processor (e.g., including processing circuitry) 240, a digital-to-analog converter (DAC) 250, an audio output mixer 260, and/or an audio output interface (e.g., including circuitry) 270.

The audio input interface 210 may include various circuitry and receive an audio signal corresponding to a sound obtained from the outside of an electronic device (e.g., the electronic device 101 in FIG. 1) via a microphone (e.g., a dynamic microphone, a condenser microphone, or a piezo microphone) that is configured as part of an input module (e.g., the input module 150 in FIG. 1) or separately from the electronic device (e.g., the electronic device 101 in FIG. 1). For example, if an audio signal is obtained from an external electronic device (e.g., the external electronic device 102 in FIG. 1) (e.g., a headset or a microphone), the audio input interface 210 may be connected with the external electronic device (e.g., the external electronic device 102 in FIG. 1) directly via a connecting terminal (e.g., the connecting terminal 178 in FIG. 1), or wirelessly (e.g., Bluetooth™ communication) via a wireless communication module (e.g., the wireless communication module 192 in FIG. 1) to receive the audio signal. According to an embodiment, the audio input interface 210 may receive a control signal (e.g., a volume adjustment signal received via an input button) related to the audio signal obtained from the external electronic device (e.g., the external electronic device 102 in FIG. 1). The audio input interface 210 may include a plurality of audio input channels and may receive a different audio signal via a corresponding one of the plurality of audio input channels, respectively. According to an embodiment, additionally or alternatively, the audio input interface 210 may receive an audio signal from another component (e.g., the processor 120 or the memory 130 in FIG. 1) of the electronic device (e.g., the electronic device 101 in FIG. 1).

The audio input mixer 220 may synthesize a plurality of inputted audio signals into at least one audio signal. For example, according to an embodiment, the audio input mixer 220 may synthesize a plurality of analog audio signals inputted via the audio input interface 210 into at least one analog audio signal.

The ADC 230 may convert an analog audio signal into a digital audio signal. According to an embodiment, the ADC 230 may convert an analog audio signal received via the audio input interface 210 or, additionally or alternatively, an analog audio signal synthesized via the audio input mixer 220 into a digital audio signal.

The audio signal processor 240 may include various processing circuitry (see, e.g., processor 120 of FIG. 1) perform various processing on a digital audio signal received via the ADC 230 or a digital audio signal received from another component of the electronic device (e.g., the electronic device 101 in FIG. 1). According to an embodiment, the audio signal processor 240 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment, one or more functions of the audio signal processor 240 may be implemented in the form of an equalizer.

The DAC 250 may convert a digital audio signal into an analog audio signal. According to an embodiment, the DAC 250 may convert a digital audio signal processed by the audio signal processor 240 or a digital audio signal obtained from another component (e.g., the processor 120 or the memory 130) of the electronic device (e.g., the electronic device 101 in FIG. 1) into an analog audio signal.

The audio output mixer 260 may synthesize a plurality of audio signals, which are to be outputted, into at least one audio signal. According to an embodiment, the audio output mixer 260 may synthesize an analog audio signal converted by the DAC 250 and another analog audio signal (e.g., an analog audio signal received via the audio input interface 210) into at least one analog audio signal.

The audio output interface 270 may include various circuitry and output an analog audio signal converted by the DAC 250 or, additionally or alternatively, an analog audio signal synthesized by the audio output mixer 260 to the outside of the electronic device (e.g., the electronic device 101 in FIG. 1) via a sound output module (e.g., the sound output module 155 in FIG. 1). The sound output module (e.g., the sound output module 155 in FIG. 1) may include, for example, a speaker, such as a dynamic driver or a balanced armature driver, or a receiver. According to an embodiment, the sound output module (e.g., the sound output module 155 in FIG. 1) may include a plurality of speakers. In such a case, the audio output interface 270 may output audio signals having a plurality of different channels (e.g., stereo channels or 5.1 channels) via at least some of the plurality of speakers. According to an embodiment, the audio output interface 270 may be connected with the external electronic device (e.g., the external electronic device 102 in FIG. 1) (e.g., an external speaker or a headset) directly via a communicating terminal (e.g., the connecting terminal 178 in FIG. 1) or wirelessly via the wireless communication module (e.g., the wireless communication module 192 in FIG. 1) to output an audio signal.

According to an embodiment, the audio module 170 may generate, without separately including the audio input mixer 220 or the audio output mixer 260, at least one digital audio signal by synthesizing a plurality of digital audio signals using at least one function of the audio signal processor 240.

According to an embodiment, the audio module 170 may include an audio amplifier (not shown) (e.g., a speaker amplifying circuit) that is capable of amplifying an analog audio signal inputted via the audio input interface 210 or an audio signal that is to be outputted via the audio output interface 270. According to an embodiment, the audio amplifier may be configured as a module separate from the audio module 170.

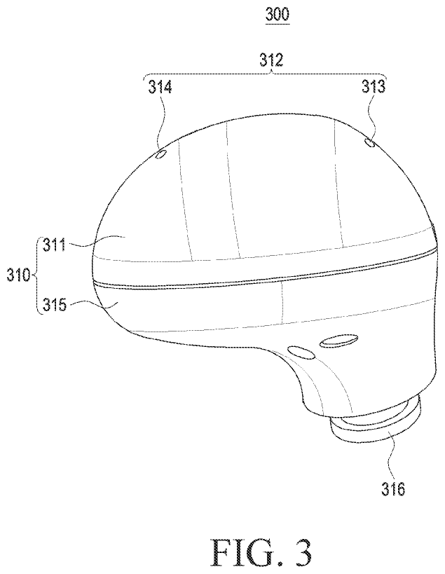

FIG. 3 is a diagram illustrating a side view of an electronic device according to various embodiments.

Referring to FIG. 3, an electronic device 300 (e.g., the electronic device 101 in FIG. 1) may include a housing 310 to accommodate components of the electronic device 300. For example, the housing 310 may have acoustic components (e.g., the audio module 170 in FIG. 2) and/or electronic components (e.g., the processor 120, the power management module 188, the battery 189, or the wireless communication module 192 in FIG. 1) disposed therein. The configuration of the electronic device 300 in FIG. 3 may be partially or wholly identical to that of the electronic device 101 in FIG. 1.

According to various embodiments, the electronic device 300 may include a wearable electronic device. The electronic device 300 may be wearable on a part of the body, such as an ear or the head. According to an embodiment, the electronic device 300 may include an in-ear earset, an in-ear headset, or a hearing aid.

According to various embodiments, the electronic device 300 may have an asymmetrical shape, as illustrated in FIG. 3. According to an embodiment, as the electronic device 300 is formed to have an asymmetrical shape, it may be ergonomically designed and increase ease of use for a user. According to an embodiment, as the electronic device 300 is formed to have an asymmetrical shape, the acoustic components (e.g., the audio module 170 in FIG. 2) and the electronic components (e.g., the processor 120 in FIG. 1) may be disposed inside the housing 310 such that acoustic performance is improved.

According to various embodiments, the electronic device 300 may be electrically connected to an external electronic device (e.g., the external electronic device 102 in FIG. 1). According to an embodiment, the electronic device 300 may function as an audio output interface (or the sound output module 155 in FIG. 1) that outputs an acoustic signal received from the external electronic device (e.g., the external electronic device 102 in FIG. 1). Additionally or alternatively, the electronic device 300 of the disclosure may function as an audio input interface (or the input module 150 in FIG. 1) to receive an audio signal corresponding to sound obtained from the outside of the electronic device 300.

According to an embodiment, the electronic device 300 may also communicate with and/or be controlled by the external electronic device (e.g., the external electronic device 102 in FIG. 1). The electronic device 300 may be an interactive electronic device which is paired with the external electronic device, such as a smartphone, through a communication scheme such as Bluetooth to convert data received from the external electronic device to output sound or to receive a user's voice and transmit it to the external electronic device.

According to an embodiment, the electronic device 300 may be wirelessly connected to the external electronic device (e.g., the external electronic device 102 in FIG. 1). For example, the electronic device 300 may communicate with the external electronic device via a network (e.g., a local area network (LAN) or a wide area network). For example, the network may include, but is not limited to, a cellular communication network, a LAN (e.g., Bluetooth communication), a wireless local area network (WLAN), the Internet, or a small area network (SAN). According to an embodiment, the electronic device 300 may be wiredly connected to the external electronic device via a cable.

According to an embodiment, the electronic device 300 may not communicate with the external electronic device (e.g., the external electronic device 102 in FIG. 1). In this case, the electronic device 300 may be implemented to receive a signal corresponding to externally obtained sound and output an acoustic signal to the outside based on operations (or control) of components included in the electronic device 300, without being controlled by the external electronic device. For example, the electronic device 300 may be a stand-alone electronic device which plays music or a video on its own without communicating with the external electronic device and outputs sound accordingly or which receives and processes the user's voice.

Various drawings of the disclosure may mainly illustrate a canal-type in-ear earset to be mounted in the ear canal extending from the auricle to the eardrum, as an example of the electronic device 300. However, it is to be noted that the disclosure is not limited thereto. According to an embodiment (not shown), the electronic device 300 may be described as an open-type earset to be mounted on the auricle.

According to various embodiments, the housing 310 may include a plurality of components. For example, the housing 310 may include a first housing 311 and a second housing 315 connected to and/or coupled to the first housing 311. According to an embodiment, the first housing 311 and the second housing 315 may form at least a portion of the exterior of the electronic device 300 and form an internal space in which components of the electronic device 300 are accommodated. According to an embodiment, with the electronic device 300 worn on the user, at least a portion of the second housing 315 may contact or face the user's body (e.g., an ear), and at least a portion of the first housing 311 may face an opposite direction of the user.

According to various embodiments, the housing 311 may include a microphone hole 312. According to an embodiment, the microphone hole 312 may be understood as a through hole formed on the first housing 311. According to an embodiment, sound from the outside of the electronic device 300 may pass through the microphone hole 312 and be transmitted to a microphone module (not shown) (e.g., the input module 150 in FIG. 1) located inside the electronic device 300. According to an embodiment, the microphone hole 312 may include a plurality of microphone holes 313 and 314. For example, the microphone hole 312 may include a first microphone hole 313 and/or a second microphone hole 314 spaced apart from the first microphone hole 313.

According to various embodiments, the housing 310 may include a protrusion 316. According to an embodiment, at least a portion of the protrusion 316 may be inserted into the user's body (e.g., an ear). For example, the electronic device 300 may be inserted and mounted on the user's body (e.g., in an ear canal or auricle of the body) using the protrusion 316. According to an embodiment, the protrusion 316 may be understood as a portion of the housing 310 extending from the second housing 315. According to an embodiment, the protrusion 316 may be further equipped with an ear tip (not shown), and the electronic device 300 may be brought into close contact with the user's ear using the ear tip. According to an embodiment, the protrusion 316 may include at least one recess (not shown), and sound output from a speaker module (not shown) (e.g., the audio module 170 in FIG. 2) disposed inside the electronic device 300 may be emitted to the outside of the electronic device 300 using the recess located on the protrusion 316.

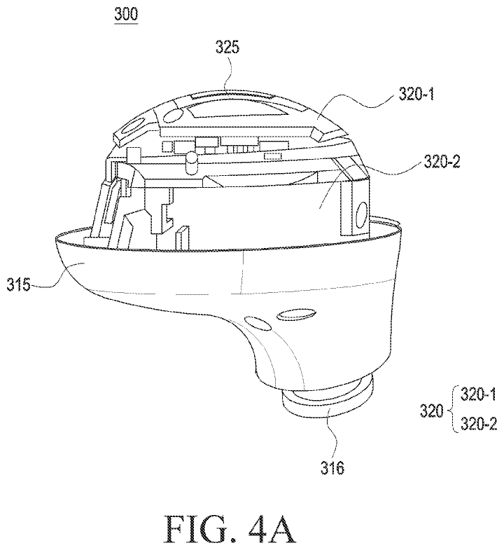

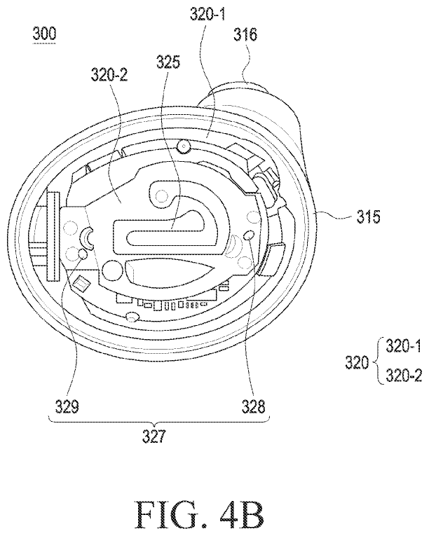

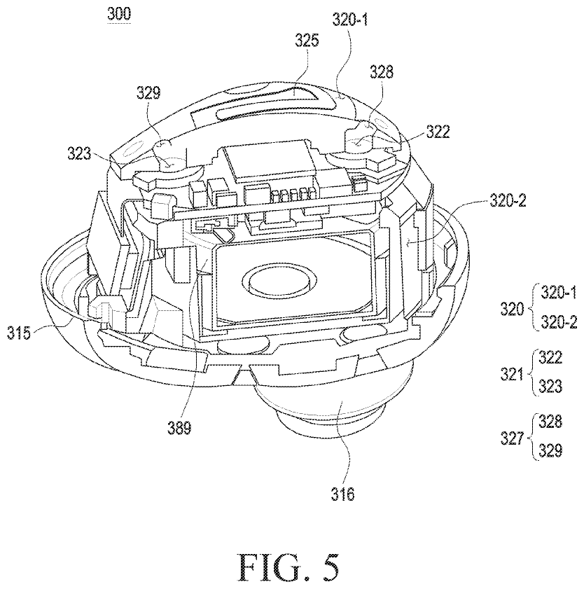

FIG. 4A is a diagram illustrating a side view of an electronic device without a first housing according to various embodiments. FIG. 4B is a diagram illustrating a top view of an electronic device without a first housing according to various embodiments. FIG. 5 is a perspective view illustrating a cut portion of an electronic device without a first housing according to various embodiments.

Referring to FIG. 4A, FIG. 4B, and/or FIG. 5, the electronic device 300 (e.g., the electronic device 101 in FIG. 1 or the electronic device 300 in FIG. 3) may include the first housing (not shown), the second housing 315, the protrusion 316, a support member 320, a microphone chamber 321, an antenna structure 325, a connection path 327, and/or a battery 389.

The configuration of the first housing (not shown), the second housing 315, and/or the protrusion 316 in FIG. 4A, FIG. 4B, and/or FIG. 5 may be partially or wholly identical to that of the first housing 311, the second housing 315, and/or the protrusion 316 in FIG. 3. The configuration of the battery 389 in FIG. 5 may be partially or wholly identical to that of the battery 189 in FIG. 1.

According to various embodiments, the support member (e.g., a support) 320 may be disposed inside the housing (e.g., the housing 310 in FIG. 3). For example, at least a portion of the support member 320 may be surrounded by the first housing (not shown) (e.g., the first housing 311 in FIG. 3) and the second housing 315 (e.g., the second housing 315 in FIG. 3). According to an embodiment, the support member 320 may include a first support member 320-1 and a second support member 320-2. The first support member 320-1 may be used as an antenna carrier which may include an antenna pattern. According to an embodiment, at least a portion (e.g., the first support member 320-1) of the support member 320 may be integrally formed with the first housing (not shown) (e.g., the first housing 311 in FIG. 3). For example, the first support member 320-1 may be connected to the first housing (not shown) (e.g., the first housing 311 in FIG. 3) by insert injection molding or double shot injection molding. According to an embodiment, the first housing (not shown) (e.g., the first housing 311 in FIG. 3) may be coupled to the second housing 315, while being connected to the first support member 320-1. According to an embodiment, the microphone chamber 321 and/or the connection path 327 may be formed or located in the first support member 320-1. According to an embodiment, the support member 320 may include the second support member 320-2 (e.g., an inner housing) that supports at least a portion of a component (e.g., the battery 389) of the electronic device 300. According to an embodiment, the first support member 320-1 may be connected to the second support member 320-2. According to an embodiment, the first support member 320-1 may be integrally formed with the second support member 320-2.

According to various embodiments, the support member 320 (e.g., the first support member 320-1) may include the antenna structure 325. According to an embodiment, the configuration of the antenna structure 325 may be partially or wholly identical to that of the antenna module 197 in FIG. 1. According to an embodiment, the antenna structure 325 may be a laser direct structuring (LDS) antenna formed on the support member 320. For example, the support member 320 may include a pattern formed of a thermoplastic resin (e.g., polycarbonate) using a laser and the thermoplastic resin. The antenna structure 325 may include a metal (e.g., copper (Cu) and/or nickel (Ni)) disposed or plated on the pattern of the support member 320.

According to various embodiments, the antenna structure 325 may be disposed on a surface of the support member 320. According to an embodiment, the antenna structure 325 may face the first housing (e.g., the first housing 311 in FIG. 3). According to an embodiment, the antenna structure 325 may be located between the first microphone hole (e.g., the first microphone hole 313 in FIG. 3) and the second microphone hole (e.g., the second microphone hole 314 in FIG. 3). For example, the antenna structure 325 may be located between a first connection path 328 and a second connection path 329.

According to various embodiments, the support member 320 may include the microphone chamber 321. According to an embodiment, the microphone chamber 321 may receive sound external to the electronic device 300 from the microphone hole (not shown) (e.g., the microphone hole 312 in FIG. 3). For example, external sound or vibration of the electronic device 300 may be transmitted to the microphone module (e.g., the input module 150 in FIG. 1) via the microphone hole (e.g., the microphone hole 312 in FIG. 3) and the microphone chamber 321. According to an embodiment, the microphone chamber 321 may be understood as a hollow space formed in the support member 320. According to an embodiment, the microphone chamber 321 may include at least one microphone chamber 322 and 323. For example, microphone chamber 321 may include a first microphone chamber 322 connected to the first microphone hole (not shown) (e.g., the first microphone hole 312 in FIG. 3) and configured to receive sound from the first microphone hole 312, and/or a second microphone chamber 323 connected to the second microphone hole (not shown) (e.g., the second microphone hole 313 in FIG. 3) and configured to receive sound from the second microphone hole 313.

According to various embodiments, the support member 320 may include the connection path 327. According to an embodiment, the connection path 327 may connect the microphone hole (not shown) (e.g., the microphone hole 312 in FIG. 3) and the microphone chamber 321 to each other. For example, the connection path 327 may extend from the microphone chamber 321 and face at least a portion of the microphone hole 312. According to an embodiment, sound from the outside of the electronic device 300 may be transmitted to the microphone chamber 321 via the microphone hole 312 and the connection path 327. According to an embodiment, the connection path 327 may be understood as a hollow space formed in the support member 320. According to an embodiment, the connection path 327 may be understood as a structure spatially connected to the microphone hole 312.

According to an embodiment, the connection path 327 may include at least one connection path 328 and 329. For example, connection path 327 may include the first connection path 328 facing at least a portion of the first microphone hole (not shown) (e.g., the first microphone hole 312 in FIG. 3) and/or the second connection path 329 spaced apart from the first connection path 328 and facing at least a portion of the second microphone hole (not shown) (e.g., the second microphone hole 313 in FIG. 3). The first connection path 328 may extend from the first microphone chamber 322 toward the first microphone hole (not shown) (e.g., the first microphone hole 312 in FIG. 3), and the second connection path 329 may extend from the second microphone chamber 323 toward the second microphone hole (not shown) (e.g., the second microphone hole 313 in FIG. 3).

According to various embodiments, the battery 389 (e.g., the battery 189 in FIG. 1) may be supported at least partially by the second support member 320-2. According to an embodiment, the battery 389 may supply power to at least one component of the electronic device 300.

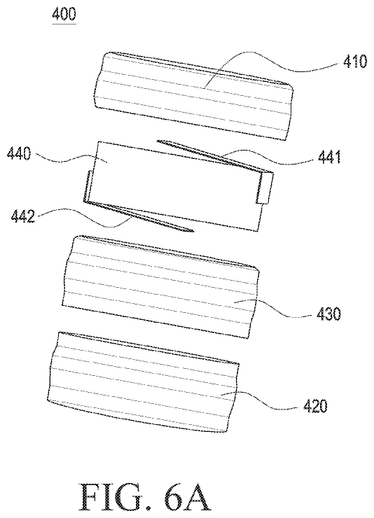

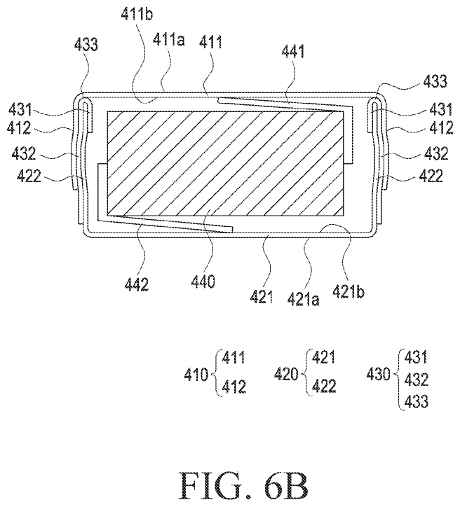

FIG. 6A is an exploded perspective view illustrating a battery according to various embodiments. FIG. 6B is a cross-sectional view illustrating a battery according to various embodiments.

According to various embodiments, a battery 400 may include a first exterior member (e.g., including a cap) 410, a second exterior member (e.g., including a cap) 420, a sealing member (e.g., including a sealing material) 430, and/or an electrode assembly (e.g., including at least one electrode) 440.

The configuration of the battery 400 in FIG. 6A and/or FIG. 6B may be partially or wholly identical to that of the battery 389 in FIG. 5.

According to various embodiments, the battery 400 may be disposed within a housing (not shown) (e.g., the housing 310 in FIG. 3) of an electronic device (not shown) (e.g., the electronic device 101 in FIG. 1 or the electronic device 300 in FIGS. 3 to 5).

According to various embodiments, the first exterior member 410 may have a cup shape (e.g., a cap) that is at least partially concave. According to an embodiment, the first exterior member 410 may include a first planar portion 411 having a substantially circular cross-sectional shape and a first diameter portion 412 extending continuously in a first direction along an edge of the first planar portion 411. According to an embodiment (not shown), the first planar portion 411 may have a polygonal cross-sectional shape or a variety of cross-sectional shapes. According to an embodiment, the first planar portion 411 may include an outer surface 411a facing the outside of the battery 400 and an inner surface 411b facing the inside of the battery 400. According to an embodiment, at least a portion of the outer surface 411a of the first planar portion 411 may form an anode or a cathode. For example, at least a portion of the outer surface 411a of the first planar portion 411 may form an anode (or a cathode), and at least a portion of an outer surface 421a of a second planar portion 421 of the second exterior member 420 may form a cathode (or an anode). According to various embodiments, the first exterior member 410 may include, but is not limited to, a stainless steel (SUS) material. According to an embodiment, the first exterior member 410 may be coupled to the sealing member 430 to cover (or close) a top surface of the sealing member 430.

According to various embodiments, the second exterior member 420 may have a cup shape (e.g., a cap) that is at least partially concave. According to an embodiment, the second exterior member 420 may include the second planar portion 421 having a substantially circular cross-sectional shape and a second diameter portion 422 extending continuously in the first direction along an edge of the second planar portion 421. According to an embodiment (not shown), the second planar portion 421 may have a polygonal cross-sectional shape or a variety of cross-sectional shapes. According to an embodiment, the second planar portion 421 may include the outer surface 421a facing the outside of the battery 400 and an inner surface 421b facing the inside of the battery 400. According to an embodiment, at least a portion of the outer surface 421a of the second planar portion 421 may form an anode or a cathode. For example, at least a portion of the outer surface 421a of the second planar portion 421 may form an anode (or a cathode), and at least a portion of the outer surface 411a of the first planar portion 411 of the first exterior member 410 may form a cathode (or an anode). According to an embodiment, the diameter of the second planar portion 421 and/or the second diameter portion 422 may be less than the diameter of the first planar portion 411 and/or the first diameter portion 412. According to various embodiments, the second exterior member 420 may include, but is not limited to, a stainless steel (SUS) material. According to an embodiment, the second exterior member 420 may be coupled to the sealing member 430 to cover (or close) a bottom surface of the sealing member 430.

According to various embodiments, the sealing member 430 (e.g., a seal comprising a sealing material) may be coupled to the first exterior member 410 and the second exterior member 420 and seal between the first exterior member 410 and the second exterior member 420. According to various embodiments, the sealing member 430 may have a ring shape with a first surface (e.g., the top surface) and a second surface (e.g., the bottom surface) opened. According to an embodiment, one open surface of the sealing member 430 may be closed by the first exterior member 410. According to an embodiment, the other open surface of the sealing member 430 may be closed by the second exterior member 420. According to an embodiment, the sealing member 430 may include an inner diameter portion 431, an outer diameter portion 432, and/or a connecting portion 433. According to various embodiments, the sealing member 430 may include various sealing materials, such as, for example, but not limited to, a polyether ether ketone (PEEK) and/or polytetrafluoroethylene (PTFE) material having properties of chemical resistance, lubricity, heat resistance, insulation, and/or high temperature water resistance.

According to an embodiment, the inner diameter portion 431 may extend from the connecting portion 433. According to an embodiment, the inner diameter portion 431 may be in the shape of a ring with any diameter and have any thickness (e.g., a thickness in a vertical direction in FIG. 6B). The diameter of the inner diameter portion 431 may be less than the diameter of the second diameter portion 422.

According to an embodiment, the outer diameter portion 432 may extend from the connecting portion 433. According to an embodiment, the outer diameter portion 432 may be in the shape of a ring with any diameter and have any thickness (e.g., a thickness in the vertical direction in FIG. 6B). According to an embodiment, the outer diameter portion 432 may be spaced apart from the inner diameter portion 431 by any distance. For example, the diameter of the outer diameter portion 432 may be greater than the diameter of the second diameter portion 422 and/or the diameter of the inner diameter portion 431, and less than the diameter of the first diameter portion 412. For example, the thickness of the outer diameter portion 432 (e.g., the thickness in the vertical direction in FIG. 6B) may be greater than the thickness of the inner diameter portion 431 (e.g., the thickness in the vertical direction in FIG. 6B).

According to an embodiment, the connecting portion 433 may connect the inner diameter portion 431 and the outer diameter portion 432 to each other. According to an embodiment, the connecting portion 433 may have a bent shape to have any curvature.

According to various embodiments, the electrode assembly 440 may be accommodated in the second exterior member 420. According to an embodiment, the electrode assembly 440 may be a jelly-roll type electrode assembly formed by rolling up a stack of an anode, a cathode, and a separator. According to an embodiment, the electrode assembly 440 may be a stack-type electrode assembly formed by stacking an anode plate, a cathode plate, and a separator. According to various embodiments, the size and/or volume of the electrode assembly 440 may be less than the size and/or volume of an internal space of the battery 400.

According to various embodiments, the battery 400 may include a first electrode tab 441 and a second electrode tab 442. The first electrode tab 441 may electrically connect the electrode assembly 440 and the first exterior member 410 to each other, and the second electrode tab 442 may electrically connect the electrode assembly 440 and the second exterior member 420 to each other. According to an embodiment, the first electrode tab 441 may extend from an outer circumferential surface of the electrode assembly 440 or from a position adjacent to the outer circumferential surface and be connected to the inner surface 411b of the first planar portion 411 of the first exterior member 410. According to an embodiment, the second electrode tab 442 may extend from an outer circumferential surface of the electrode assembly 440 or from a position adjacent to the outer circumferential surface and be connected to the inner surface 421b of the second planar portion 421 of the second exterior member 420. In an embodiment, the first electrode tab 441 and/or the second electrode tab 442 may be understood as a partial configuration of the battery 400. In an embodiment, the first electrode tab 441 and/or the second electrode tab 442 may be understood as a partial configuration of the electrode assembly 440. According to an embodiment, the first electrode tab 441 and/or the second electrode tab 442 may include, but is not limited to, nickel (Ni) and/or aluminum (Al).

According to various embodiments, an electrolyte (not shown) may be injected into the second exterior member 420. As the electrode assembly 440 is accommodated in the second exterior member 420 and the electrolyte is injected into the second exterior member 420, an environment for ions to move between an anode and a cathode of the electrode assembly 440 may be provided. For example, the battery 400 may be charged or discharged by movement of ions through the electrolyte and movement of electrons corresponding to the movement of the ions through the first electrode tab 441 and the second electrode tab 442.

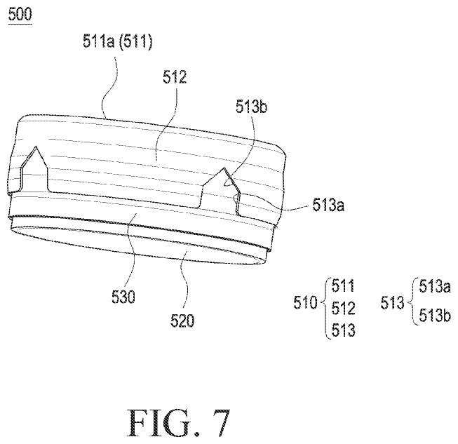

FIG. 7 is a perspective view illustrating a battery according to various embodiments.

Referring to FIG. 7, a battery 500 (e.g., the battery 400 in FIGS. 6A and 6B) may include a first exterior member (e.g., including a cap) 510, a second exterior member (e.g., including a cap) 520, a sealing member (e.g., including a sealing material) 530, and/or an electrode assembly (not shown).

The configuration of the first exterior member 510, the second exterior member 520, the sealing member 530, and/or the electrode assembly (not shown) in FIG. 7 may be partially or wholly identical to that of the first exterior member 410, the second exterior member 420, the sealing member 430, and/or the electrode assembly 440 in FIGS. 6A and 6B.

According to various embodiments, the battery 500 may include a vent structure 513 formed on at least one of edge regions of the sealing member 530 (e.g., the sealing member 430 in FIGS. 6A and 6B), the first exterior member 510 (e.g., the first exterior member 410 in FIGS. 6A and 6B), and the second exterior member 520 (e.g., the second exterior member 420 in FIGS. 6A and 6B), for communicating between the inside and outside of the battery 500.

According to various embodiments, the first exterior member 510 may include a first planar portion 511 (e.g., the first planar portion 411 in FIGS. 6A and 6B) including an inner surface (not shown) (e.g., the inner surface 411b in FIGS. 6A and 6B) and an outer surface 511a (e.g., the outer surface 411a in FIGS. 6A and 6B), a first diameter portion 512 (e.g., the first diameter portion 412 in FIGS. 6A and 6B), and/or the vent structure 513.

According to an embodiment, the vent structure 513 may be a groove (or slit) recessed upward from at least a portion of a bottom edge region of the first exterior member 510. For example, the vent structure 513 may be formed in a bottom edge region of the first diameter portion 512, and at least one vent structure 513 may be formed. According to an embodiment, the vent structure 513 may include a first portion 513a having a width equal to any thickness and a second portion 513b having a width gradually decreasing from the top of the first portion 513a in the bottom edge region of the first diameter portion 512. According to an embodiment (not shown), the shape of the vent structure 513 may vary depending on the design. In an embodiment, the vent structure 513 may be understood as a partial configuration of the battery 500. In an embodiment, the vent structure 513 may be understood as a partial configuration of the first exterior member 510.

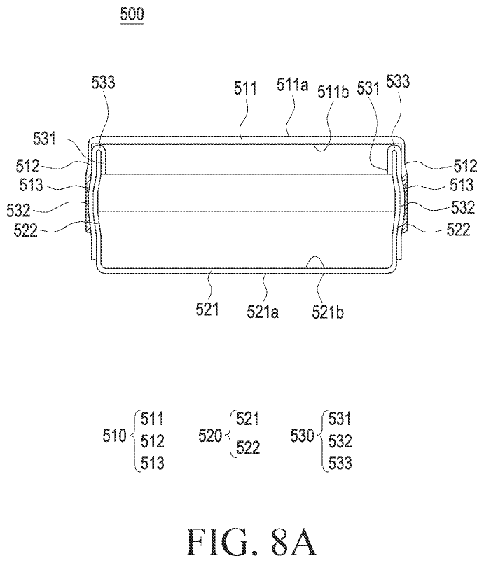

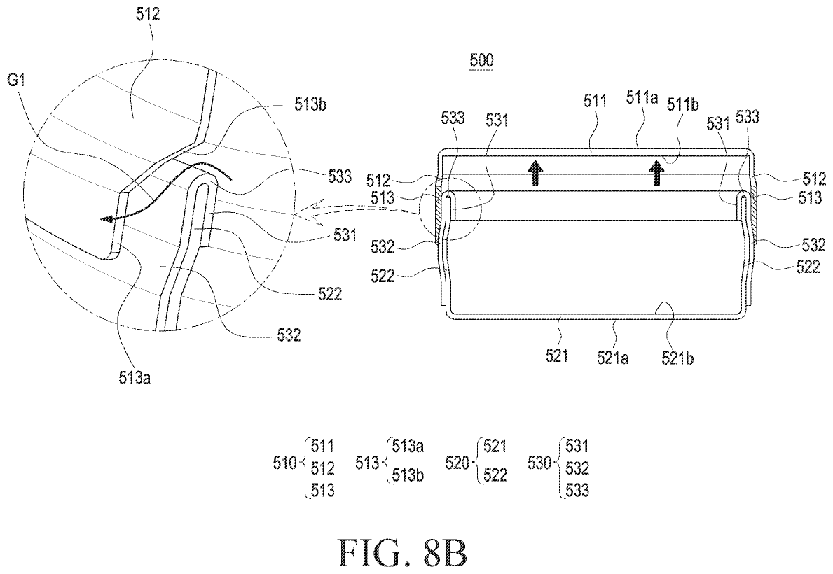

FIG. 8A is a cross-sectional view illustrating an assembled battery according to various embodiments. FIG. 8B is a cross-sectional view illustrating gas venting from a battery according to various embodiments.

According to various embodiments, the battery 500 (e.g., the battery 500 in FIG. 7) may include the first exterior member (e.g., including a cap) 510, the vent structure (e.g., including a vent) 513, the second exterior member (e.g., including a cap) 520, the sealing member (e.g., including a sealing material) 530, and/or the electrode assembly (not shown).

The configuration of the first exterior member 510, the vent structure 513, the second exterior member 520, and/or the sealing member 530 in FIG. 8A and/or FIG. 8B may be partially or wholly identical to that of the first exterior member 510, the vent structure 513, the second exterior member 520, and/or the sealing member 530 in FIG. 7. The configuration of the electrode assembly (not shown) in FIG. 8A and/or FIG. 8B may be partially or wholly identical to that of the electrode assembly 440 in FIGS. 6A and 6B.

According to various embodiments, the first exterior member 510 (e.g., the first exterior member 510 in FIG. 7) may include the first planar portion 511 (e.g., the first planar portion 511 in FIG. 7) including an inner surface 511b (e.g., the inner surface 411b in FIGS. 6A and 6B) and the outer surface 511a (e.g., the outer surface 511a in FIG. 7), the first diameter portion 512 (e.g., the first diameter portion 512 in FIG. 7), and/or the vent structure 513 (e.g., the vent structure 513 in FIG. 7) including the first portion 513a (e.g., the first portion 513a in FIG. 7) and the second portion 513b (e.g., the second portion 513b in FIG. 7).

According to various embodiments, the second exterior member 520 (e.g., the second exterior member 520 in FIG. 7) may include a second planar portion 521 (e.g., the second planar portion 421 in FIGS. 6A and 6B) including an inner surface 521b (e.g., the inner surface 421b in FIGS. 6A and 6B) and an outer surface 521a (e.g. the outer surface 421a in FIGS. 6A and 6B), and/or a second diameter portion 522 (e.g., the second diameter portion 422 in FIGS. 6A and 6B).

According to various embodiments, the sealing member 530 (e.g., the sealing member 530 in FIG. 7) may include an inner diameter portion 531 (e.g., the inner diameter portion 431 in FIGS. 6A and 6B), an outer diameter portion 532 (e.g., the outer diameter portion 432 in FIGS. 6A and 6B), and/or a connecting portion 533 (e.g., the connecting portion 433 in FIGS. 6A and 6B).

According to various embodiments, the electrode assembly (not shown) (e.g., the electrode assembly 440 in FIGS. 6A and 6B) may be electrically connected to the first exterior member 510 via a first electrode tab (not shown) (e.g., the first electrode tab 441 in FIGS. 6A and 6B) and electrically connected to the second exterior member 520 via a second electrode tab (not shown) (e.g., the second electrode tab 442 in FIGS. 6A and 6B).

According to various embodiments, in an assembled (or manufactured) state of the battery 500, the first exterior member 510 and the second exterior member 520 may be coupled to the sealing member 530, as illustrated in FIG. 8A. For example, the first exterior member 510 may be coupled to the sealing member 530 such that the inner surface 511a of the first planar portion 511 contacts the connecting portion 533 of the sealing member 530, and the second exterior member 520 may be coupled to the sealing member 530 such that the second diameter portion 522 is inserted between the inner diameter portion 531 and the outer diameter portion 532 of the sealing member 530. The battery 500 may generate gas inside it due to long-term use, deterioration of pole plates of the electrode assembly (not shown) or an electrolyte (not shown), and/or vaporization of the electrolyte caused by an abnormal operation. As a result, the battery 500 may experience a continuous increase in internal pressure, which may cause the first exterior member 510 and/or the second exterior member 520 coupled to the sealing member 530 to be separated.

According to various embodiments, the inclusion of the vent structure 513 in the battery 500 may restrict the separation of the first exterior member 510 and/or the second exterior member 520 from the sealing member 530.

According to various embodiments, the battery 500 may be moved in a direction in which the first exterior member 510 recedes from the sealing member 530 (e.g., in an upward direction in FIG. 8B) due to increased internal pressure caused by the generation of gas within the battery 500, as illustrated in FIG. 8B.

According to various embodiments, as the vent structure 513 is moved in the direction in which the first exterior member 510 recedes from the sealing member 530, at least a portion of the second portion 513b of the vent structure 513 may be disposed above the connecting portion 533 of the sealing member 530. For example, the vent structure 513 may be configured to form a gap between the sealing member 530 and the first exterior member 510, when the internal pressure of the battery 500 is equal to or greater than an arbitrary pressure. The arbitrary pressure may be understood as a pressure to which the internal pressure of the battery 500 increases, causing the first exterior member 510 to recede from the sealing member 530. In this case, the first exterior member 510 and the sealing member 530 may form a gap between them, through which the inside and outside of the battery 500 may communicate. As illustrated in FIG. 8B, gas may be vented from the inside of the battery 500 to the outside of the battery 500 (see a path “G1” in FIG. 8B).

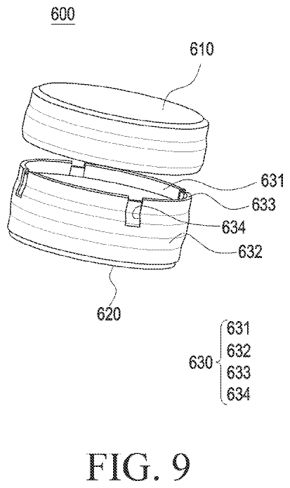

FIG. 9 is an exploded perspective view illustrating a battery with a first exterior member separated according to various embodiments.

Referring to FIG. 9, a battery 600 (e.g., the battery 400 in FIGS. 6A and 6B) may include a first exterior member (e.g., including a cap) 610, a second exterior member (e.g., including a cap) 620, a sealing member (e.g., including a sealing material) 630, and/or an electrode assembly (not shown).

The configuration of the first exterior member 610, the second exterior member 620, the sealing member 630, and/or the electrode assembly (not shown) in FIG. 9 may be partially or wholly identical to that of the first exterior member 410, the second exterior member 420, the sealing member 430, and/or the electrode assembly 440 in FIGS. 6A and 6B.

According to various embodiments, the battery 600 may include a vent structure 634 formed in at least one of edge regions of the sealing member 630 (e.g., the sealing member 430 in FIGS. 6A and 6B), the first exterior member 610 (e.g., the first exterior member 410 in FIGS. 6A and 6B), and the second exterior member 620 (e.g., the second exterior member 420 in FIGS. 6A and 6B), for communicating between the inside and outside of the battery 600.

According to various embodiments, the sealing member 630 may include an inner diameter portion 631 (e.g., the inner diameter portion 431 in FIGS. 6A and 6B), an outer diameter portion 632 (e.g., the outer diameter portion 432 in FIGS. 6A and 6B), a connecting portion 633 (e.g., the connecting portion 433 in FIGS. 6A and 6B), and/or the vent structure 634.

According to an embodiment, the vent structure 634 may be a groove (or slit) recessed downward from at least a portion of a top edge region of the sealing member 630. According to an embodiment, the vent structure 634 may be recessed toward the inner diameter portion 631 and/or the outer diameter portion 632 from a top edge region of the connecting portion 633, and at least one vent structure 634 may be formed. According to an embodiment (not shown), the shape of the vent structure 634 may vary depending on the design. In an embodiment, the vent structure 634 may be understood as a partial configuration of the battery 600. In an embodiment, the vent structure 634 may be understood as a partial configuration of the sealing member 630.

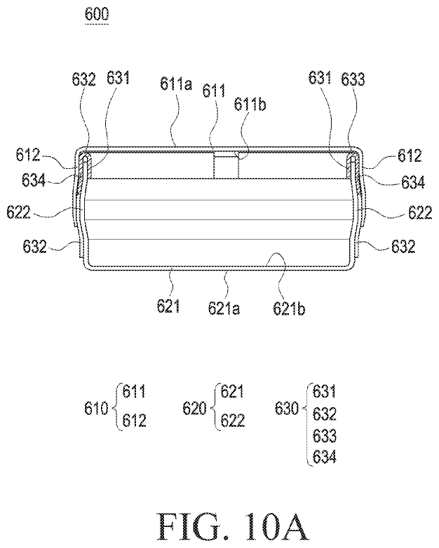

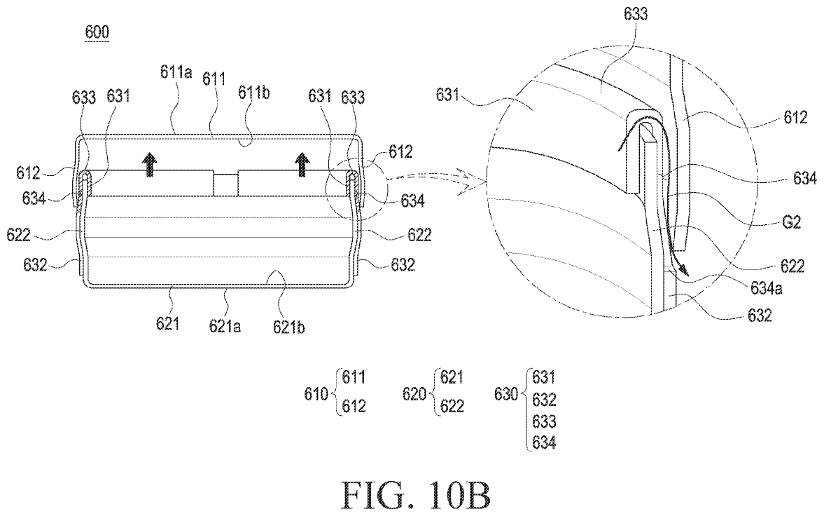

FIG. 10A is a cross-sectional view illustrating an assembled battery according to various embodiments. FIG. 10B is a cross-sectional view illustrating gas venting from a battery according to various embodiments.

According to various embodiments, the battery 600 (e.g., the battery 600 in FIG. 9) may include the first exterior member (e.g., including a cap) 610, the vent structure (e.g., including a vent) 634, the second exterior member (e.g., including a cap) 620, the sealing member (e.g., including a sealing material) 630, and/or the electrode assembly (not shown).

The configuration of the first exterior member 610, the vent structure 634, the second exterior member 620, and/or the sealing member 630 in FIG. 10A and/or FIG. 10B may be partially or wholly identical to that of the first exterior member 610, the vent structure 634, the second exterior member 620, and/or the sealing member 630 in FIG. 9. The configuration of the electrode assembly (not shown) in FIG. 10A and/or FIG. 10B may be partially or wholly identical to that of the electrode assembly 440 in FIGS. 6A and 6B.

According to various embodiments, the first exterior member 610 (e.g., the first exterior member 610 in FIG. 9) may include a first planar portion 611 (e.g., the first planar portion 411 in FIGS. 6A and 6B) including an inner surface 611b (e.g., the inner surface 411b in FIGS. 6A and 6B) and an outer surface 611a (e.g., the outer surface 411a in FIGS. 6A and 6B), and/or a first diameter portion 612 (e.g., the first diameter portion 412 in FIGS. 6A and 6B).

According to various embodiments, the second exterior member 620 (e.g., the second exterior member 620 in FIG. 9) may include a second planar portion 621 (e.g., the second planar portion 421 in FIGS. 6A and 6B) including an inner surface 621b (e.g., the inner surface 421b in FIGS. 6A and 6B) and an outer surface 621a (e.g., the outer surface 421a in FIGS. 6A and 6B), and/or a second diameter portion 622 (e.g., the second diameter portion 422 in FIGS. 6A and 6B).

According to various embodiments, the sealing member 630 (e.g., the sealing member 630 in FIG. 9) may include the inner diameter portion 631 (e.g., the inner diameter portion 631 in FIG. 9), the outer diameter portion 632 (e.g., the outer diameter portion 632 in FIG. 9), the connecting portion 633 (e.g., the connecting portion 633 in FIG. 9), and/or the vent structure 634 (e.g., the vent structure 634 in FIG. 9).

According to various embodiments, the electrode assembly (not shown) (e.g., the electrode assembly 440 in FIGS. 6A and 6B) may be electrically connected to the first exterior member 610 via a first electrode tab (not shown) (e.g., the first electrode tab 441 in FIGS. 6A and 6B) and electrically connected to the second exterior member 620 via a second electrode tab (not shown) (e.g., the second electrode tab 442 in FIGS. 6A and 6B).

According to various embodiments, in an assembled (or manufactured) state of the battery 600, the first exterior member 610 and the second exterior member 620 may be coupled to the sealing member 630, as illustrated in FIG. 10A. For example, the first exterior member 610 may be coupled to the sealing member 630 such that the inner surface 611a of the first planar portion 611 contacts the connecting portion 633 of the sealing member 630, and the second exterior member 620 may be coupled to the sealing member 630 such that the second diameter portion 622 is inserted between the inner diameter portion 631 and the outer diameter portion 632 of the sealing member 630. The battery 600 may generate gas inside it due to long-term use, deterioration of the pole plates of the electrode assembly (not shown) or the electrolyte (not shown), and/or vaporization of the electrolyte caused by an abnormal operation. As a result, the battery 600 may experience a continuous increase in internal pressure, which may cause the first exterior member 610 and/or the second exterior member 620 coupled to the sealing member 630 to be separated.

According to various embodiments, the inclusion of the vent structure 634 in the battery 600 may restrict the separation of the first exterior member 610 and/or the second exterior member 620 from the sealing member 630.

According to various embodiments, the battery 600 may be moved in a direction in which the first exterior member 610 recedes from the sealing member 630 (e.g., in an upward direction in FIG. 10B) as illustrated in FIG. 10B due to increased internal pressure caused by the generation of gas within the battery 600.

According to various embodiments, as the vent structure 634 may be moved in the direction in which the first exterior member 610 recedes from the sealing member 630, a deepest portion 634a of the vent structure 634 (e.g., a deepest portion of the vent structure 634 formed in the outer diameter portion 633) may be disposed lower than a bottom edge region of the first diameter portion 611 of the first exterior member 610. For example, the vent structure 634 may be configured to form a gap between the sealing member 630 and the first exterior member 610, when the internal pressure of the battery 600 is equal to or greater than an arbitrary pressure. The arbitrary pressure may be understood as a pressure to which the internal pressure of the battery 600 increases, causing the first exterior member 610 to recede from the sealing member 630. In this case, the first exterior member 610 and the sealing member 630 may form a gap therebetween, through which the inside and outside of the battery 600 may communicate. As illustrated in FIG. 10B, gas may be vented from the inside of the battery 600 to the outside of the battery 600 (see a path “G2” in FIG. 10B).

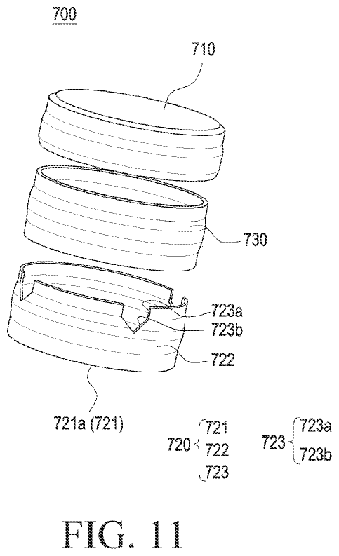

FIG. 11 is an exploded perspective view illustrating a battery according to various embodiments.

Referring to FIG. 11, a battery 700 (e.g., the battery 400 in FIGS. 6A and 6B) may include a first exterior member (e.g., including a cap) 710, a second exterior member (e.g., including a cap) 720, a sealing member (e.g., including a sealing material) 730, and/or an electrode assembly (not shown).

The configuration of the first exterior member 710, the second exterior member 720, the sealing member 730, and/or the electrode assembly (not shown) in FIG. 11 may be partially or wholly identical to that of the first exterior member 410, the second exterior member 420, the sealing member 430, and/or the electrode assembly 440 in FIGS. 6A and 6B.

According to various embodiments, the battery 700 may include a vent structure 723 formed in at least one of edge regions of the sealing member 730 (e.g., the sealing member 430 in FIGS. 6A and 6B), the first exterior member 710 (e.g., the first exterior member 410 in FIGS. 6A and 6B), and the second exterior member 720 (e.g., the second exterior member 420 in FIGS. 6A and 6B), for communicating between the inside and outside of the battery 700.

According to various embodiments, the second exterior member 720 may include a second planar portion 721 (e.g., the second planar portion 421 in FIGS. 6A and 6B) including an inner surface (not shown) (e.g., the inner surface 421b in FIGS. 6A and 6B) and an outer surface 721a (e.g., the outer surface 421a in FIGS. 6A and 6B), a second diameter portion 722 (e.g., the second diameter portion 422 in FIGS. 6A and 6B), and/or the vent structure 723.

According to an embodiment, the vent structure 723 may be a groove (or slit) recessed downward from at least a portion of a top edge region of the second exterior member 720. For example, the vent structure 723 may be formed in a top edge region of the second diameter portion 722, and at least one vent structure 723 may be formed. According to an embodiment, the vent structure 723 may include a first portion 723a having a width equal to any thickness and a second portion 723b having a width gradually decreasing from the bottom of the first portion 723a in the top edge region of the second diameter portion 722. According to an embodiment (not shown), the shape of the vent structure 723 may vary depending on the design. In an embodiment, the vent structure 723 may be understood as a partial configuration of the battery 700. In an embodiment, the vent structure 723 may be understood as a partial configuration of the second exterior member 720.

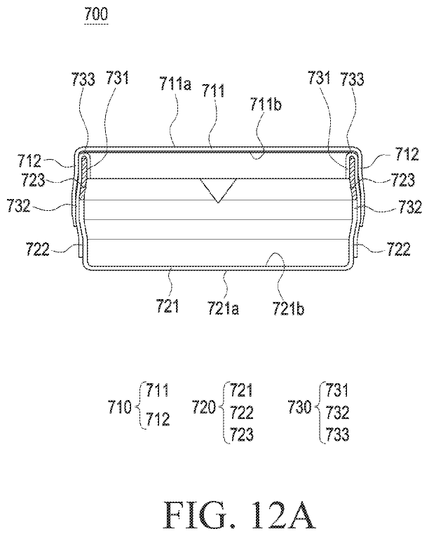

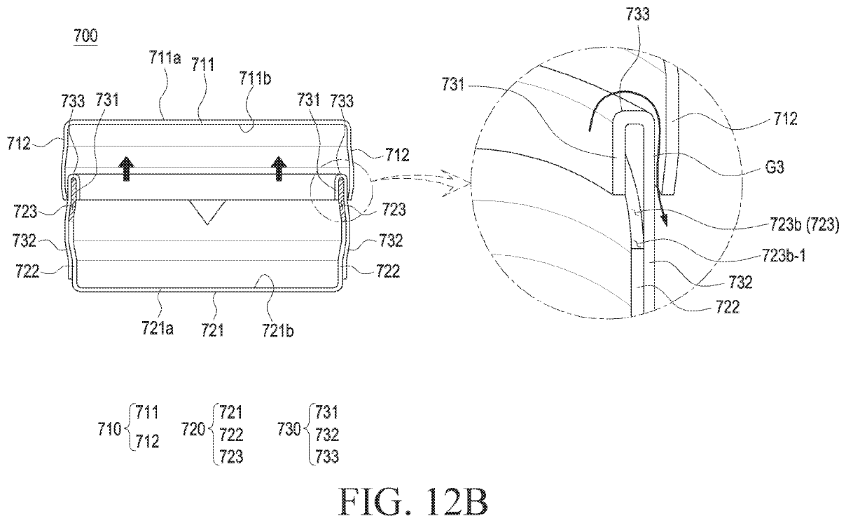

FIG. 12A is a cross-sectional view illustrating an assembled battery according to various embodiments. FIG. 12B is a cross-sectional view illustrating gas venting from a battery according to various embodiments.

According to various embodiments, the battery 700 (e.g., the battery 700 in FIG. 11) may include the first exterior member 710, the vent structure 723, the second exterior member 720, the sealing member 730, and/or the electrode assembly (not shown).

The configuration of the first exterior member 710, the vent structure 723, the second exterior member 720, and/or the sealing member 730 in FIG. 12A and/or FIG. 12B may be partially or wholly identical to that of the first exterior member 710, the vent structure 723, the second exterior member 720, and/or the sealing member 730 in FIG. 11. The configuration of the electrode assembly (not shown) of FIG. 12A and/or FIG. 12B may be partially or wholly identical to that of the electrode assembly 440 in FIGS. 6A and 6B.

According to various embodiments, the first exterior member 710 (e.g., the first exterior member 710 in FIG. 11) may include a first planar portion 711 (e.g., first planar portion 411 in FIGS. 6A and 6B) including an inner surface 711b (e.g., the inner surface 411b in FIGS. 6A and 6B) and an outer surface 711a (e.g., the outer surface 411a in FIGS. 6A to 6B), and/or a first diameter portion 712 (e.g., the first diameter portion 712 in FIG. 11).

According to various embodiments, the second exterior member 720 (e.g., the second exterior member 720 in FIG. 11) may include the second planar portion 721 (e.g., the second planar portion 721 in FIG. 11) including an inner surface 721b (e.g., the inner surface 421b in FIGS. 6A and 6B) and the outer surface 721a (e.g., the outer surface 721a in FIG. 11), the second diameter portion 722 (e.g., the second diameter portion 422 in FIGS. 6A and 6B), and/or the vent structure 723 (e.g., the vent structure 723 in FIG. 11).

According to various embodiments, the sealing member 730 (e.g., the sealing member 730 in FIG. 11) may include an inner diameter portion 731 (e.g., the inner diameter portion 431 in FIGS. 6A and 6B), an outer diameter portion 732 (e.g., the outer diameter portion 432 in FIGS. 6A and 6B), and/or a connecting portion 733 (e.g., the connecting portion 433 in FIGS. 6A and 6B).

According to various embodiments, the electrode assembly (not shown) (e.g., the electrode assembly 440 in FIGS. 6A and 6B) may be electrically connected to the first exterior member 710 via a first electrode tab (not shown) (e.g., the first electrode tab 441 in FIGS. 6A and 6B) and electrically connected to the second exterior member 720 via a second electrode tab (not shown) (e.g., the second electrode tab 442 in FIGS. 6A and 6B).

According to various embodiments, in an assembled (or manufactured) state of the battery 700, the first exterior member 710 and the second exterior member 720 may be coupled to the sealing member 730, as illustrated in FIG. 12A. For example, the first exterior member 710 may be coupled to the sealing member 730 such that the inner surface 711a of the first planar portion 711 contacts the connecting portion 733 of the sealing member 730, and the second exterior member 720 may be coupled to the sealing member 730 such that the second diameter portion 722 is inserted between the inner diameter portion 731 and the outer diameter portion 732 of the sealing member 730. The battery 700 may generate gas inside it due to long-term use, deterioration of pole plates of the electrode assembly (not shown) or an electrolyte (not shown), and/or vaporization of the electrolyte caused by an abnormal operation. As a result, the battery 700 may experience a continuous increase in internal pressure, which may cause the first exterior member 710 and/or the second exterior member 720 coupled to the sealing member 730 to be separated.

According to various embodiments, the inclusion of the vent structure 723 in the battery 700 may restrict the separation of the first exterior member 710 and/or the second exterior member 720 from the sealing member 730.

According to various embodiments, the sealing member 730 may have a corrugated shape such that an area corresponding to the vent structure 723 of the second exterior member 720 is more flexible. According to an embodiment, the sealing member 730 may have a corrugated shape because the increased internal pressure causes at least a portion (e.g., a portion corresponding to the vent structure 723 of the second diameter portion 732) to be pushed into an empty space formed by the vent structure 723. According to an embodiment, the sealing member 730 may form a specific gap between the corrugated portion and the first diameter portion 712 of the first exterior member 710.

According to various embodiments, the battery 700 may be moved in a direction in which the first exterior member 710 recedes from the sealing member 730 (e.g., in an upward direction in FIG. 12B) due to increased internal pressure caused by the generation of gas within the battery 700, as illustrated in FIG. 12B.

According to various embodiments, as the vent structure 723 is moved in the direction in which the first exterior member 710 recedes from the sealing member 730, a deepest portion 723b-1 of the vent structure 723 (e.g., a deepest portion of the second portion 723b of the vent structure 723) may be located lower than a bottom edge region of the first diameter portion 712 of the first exterior member 710. For example, the vent structure 723 may be configured to form a gap between the sealing member 730 and the first exterior member 710, when the internal pressure of the battery 700 is equal to or greater than an arbitrary pressure. The arbitrary pressure may be understood as a pressure to which the internal pressure of the battery 700 increases, causing the first exterior member 710 to recede from the sealing member 730. In this case, the specific gap formed between the first exterior member 710 and the sealing member 730 may be opened, thereby allowing communication between the inside and outside of the battery 700 through the gap. As illustrated in FIG. 12B, gas may be vented from the inside of the battery 700 to the outside (see a path “G3” in FIG. 12B).

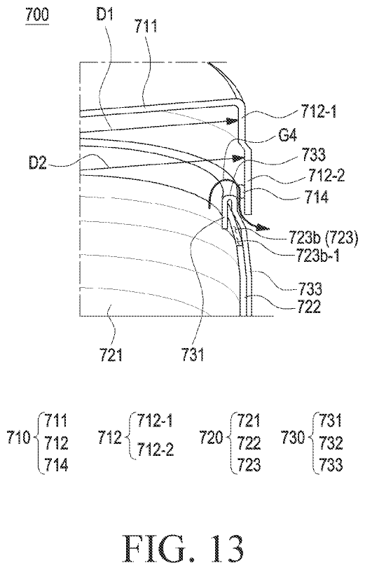

FIG. 13 is a cross-sectional perspective view illustrating a protrusion member formed on a first exterior member according to various embodiments.

Referring to FIG. 13, the battery 700 (e.g., the battery 700 in FIGS. 11 and 12B) may include the first exterior member (e.g., including a cap) 710, the second exterior member (e.g., including a cap) 720, the sealing member (e.g., including a sealing material) 730, and/or the electrode assembly (not shown).

The configuration of the first exterior member 710, the second exterior member 720, and/or the sealing member 730 in FIG. 13 may be partially or wholly identical to that of the first exterior member 710, the second exterior member 720, and/or the sealing member 730 in FIGS. 11 to 12B. The configuration of the electrode assembly (not shown) in FIG. 13 may be partially or wholly identical to that of the electrode assembly 440 in FIGS. 6A and 6B.

According to various embodiments, the first exterior member 710 (e.g., the first exterior member 710 in FIGS. 11 to 12B) may include the first planar portion 711 (e.g., the first planar portion 711 in FIGS. 11 to 12B) and the first diameter portion 712 (e.g., the first diameter portion 712 in FIGS. 11 to 12B).

According to an embodiment, the first diameter portion 712 may include a (1-1)^{th} diameter portion 712-1 and a (1-2)^{th} diameter portion 712-2. For example, the (1-1)^{th} diameter portion 712-1 may extend from an edge of the first planar portion 711, and the (1-2)^{th} diameter portion 712-2 may extend from the (1-1)^{th} diameter portion 712-1. According to an embodiment, the diameter D1 of the (1-1)^{th} diameter portion 712-1 may be less than the diameter D2 of the (1-2)^{th} diameter portion 712-2.

According to various embodiments, the first exterior member 710 may further include a protrusion member 714. According to an embodiment, the protrusion member 714 may be formed on an inner surface of the first diameter portion 712, facing the inside of the battery 700. For example, the protrusion member 714 may be formed on an inner surface of the (1-2)^{th} diameter portion 712-2, facing the inside of the battery 700. According to an embodiment, the protrusion member 714 may correspond to the vent structure 723 in number and position.

According to various embodiments, in an assembled (or manufactured) state of the battery 700, the first exterior member 710 and the second exterior member 720 may be coupled to the sealing member 730. For example, the first exterior member 710 may be coupled to the sealing member 730 such that the inner surface 711a of the first planar portion 711 contacts the connecting portion 733 of the sealing member 730, and the second exterior member 720 may be coupled to the sealing member 730 such that the second diameter portion 722 is inserted between the inner diameter portion 731 and the outer diameter portion 732 of the sealing member 730. The battery 700 may generate gas inside it due to long-term use, deterioration of pole plates of the electrode assembly (not shown) or an electrolyte (not shown), and/or vaporization of the electrolyte caused by an abnormal operation. As a result, the battery 700 may experience a continuous increase in internal pressure, which may cause the first exterior member 710 and/or the second exterior member 720 coupled to the sealing member 730 to be separated.

According to various embodiments, the inclusion of the vent structure 723 in the battery 700 may restrict the separation of the first exterior member 710 and/or the second exterior member 720 from the sealing member 730.

According to various embodiments, the sealing member 730 may have a corrugated shape in an area corresponding to the vent structure 723 of the second exterior member 720. According to an embodiment, the sealing member 730 may have a corrugated shape because at least a portion (e.g., a portion of the second diameter portion 732 corresponding to the vent structure 723) is pushed into an empty space formed by the vent structure 723. According to an embodiment, the sealing member 730 may form a specific gap between the corrugated portion and the first diameter portion 712 of the first exterior member 710.

According to various embodiments, the battery 700 may be moved in a direction in which the first exterior member 710 recedes from the sealing member 730 (e.g., in an upward direction in FIG. 13) due to increased internal pressure caused by the generation of gas within the battery 700, as illustrated in FIG. 13.

According to various embodiments, as the vent structure 723 is moved in the direction in which the first exterior member 710 recedes from the sealing member 730, the deepest portion 723b-1 of the vent structure 723 (e.g., the deepest portion of the second portion 723b of the vent structure 723) may be disposed lower than the bottom edge region of the first diameter portion 712 of the first exterior member 710. For example, the vent structure 723 may be configured to form a gap between the sealing member 730 and the first exterior member 710, when the internal pressure of the battery 700 is equal to or greater than an arbitrary pressure. The arbitrary pressure may be understood as a pressure to which the internal pressure of the battery 700 increases, causing the first exterior member 710 to recede from the sealing member 730. In this case, the predetermined gap formed between the first exterior member 710 and the sealing member 730 may be opened, thereby allowing communication between the inside and outside of the battery 700 through the gap. As illustrated in FIG. 13, gas may be vent from the inside of the battery 700 to the outside (see a path “G4” in FIG. 13). In this case, as the protruding member 714 presses against the sealing member 730, the specific gap may be further corrugated, thereby forming a larger path through which the gas is vented.

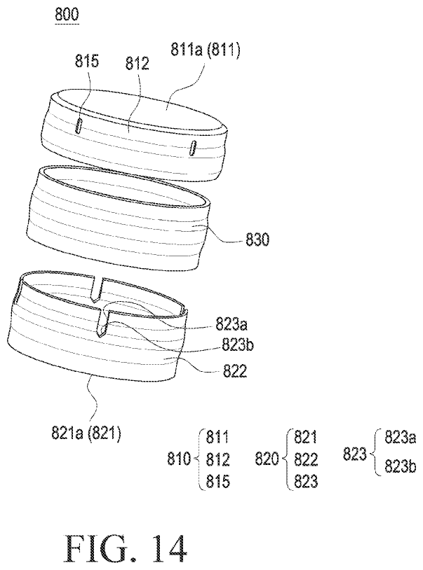

FIG. 14 is an exploded perspective view illustrating a battery according to various embodiments.

Referring to FIG. 14, a battery 800 (e.g., the battery 400 in FIGS. 6A and 6B) may include a first exterior member (e.g., including a cap) 810, a second exterior member (e.g., including a cap) 820, a sealing member (e.g., including a sealing material) 830, and/or an electrode assembly (not shown).

The configuration of the first exterior member 810, the second exterior member 820, the sealing member 830, and/or the electrode assembly (not shown) in FIG. 14 may be partially or wholly identical to that of the first exterior member 410, the second exterior member 420, the sealing member 430, and/or the electrode assembly 440 in FIGS. 6A and 6B.

According to various embodiments, the battery 800 may include a vent structure 823 formed in at least one of edge regions of the sealing member 830 (e.g., the sealing member 430 in FIGS. 6A and 6B), the first exterior member 810 (e.g., the first exterior member 410 in FIGS. 6A and 6B), and the second exterior member 820 (e.g., the second exterior member 420 in FIGS. 6A and 6B), for communicating between the inside and outside of the battery 800.

According to various embodiments, the first exterior member 810 may include a first planar portion 811 (e.g., the first planar portion 411 in FIGS. 6A and 6B) including an inner surface (not shown) (e.g., the inner surface 411b in FIGS. 6A and 6B) and an outer surface 811a (e.g., the outer surface 411a in FIGS. 6A and 6B), a first diameter portion 812 (e.g., the first diameter portion 412 in FIGS. 6A and 6B), and/or a first through hole 815.

According to an embodiment, the first through hole 815 may be formed to penetrate at least a portion of the first diameter portion 812. At least one first through hole 815 may be formed. The first through hole 815 is not limited to the illustrated shape and may have various shapes depending on design changes. In an embodiment, the first through hole 815 may be understood as a partial configuration of the battery 800. In an embodiment, the first through hole 815 may be understood as a partial configuration of the first exterior member 810.

According to various embodiments, the second exterior member 820 may include a second planar portion 821 (e.g., the second planar portion 421 in FIGS. 6A and 6B) including an inner surface (not shown) (e.g., the inner surface 421b in FIGS. 6A and 6B) and an outer surface 821a (e.g., the outer surface 421a in FIGS. 6A and 6B), a second diameter portion 822 (e.g., the second diameter portion 422 in FIGS. 6A and 6B), and/or the vent structure 823.

According to an embodiment, the vent structure 823 may be a groove (or slit) recessed downward from at least a portion of a top edge region of the second exterior member 820. For example, the vent structure 823 may be formed in a top edge region of the second diameter portion 822, and at least one vent structure 823 may be formed. According to an embodiment, the vent structure 823 may include a first portion 823a having a width equal to any thickness and a second portion 823b having a width gradually decreasing from the bottom of the first portion 823a in the top edge region of the second diameter portion 822. According to an embodiment (not shown), the shape of the vent structure 823 may vary depending on the design. In an embodiment, the vent structure 823 may be understood as a partial configuration of the battery 800. In an embodiment, the vent structure 823 may be understood as a partial configuration of the second exterior member 820.

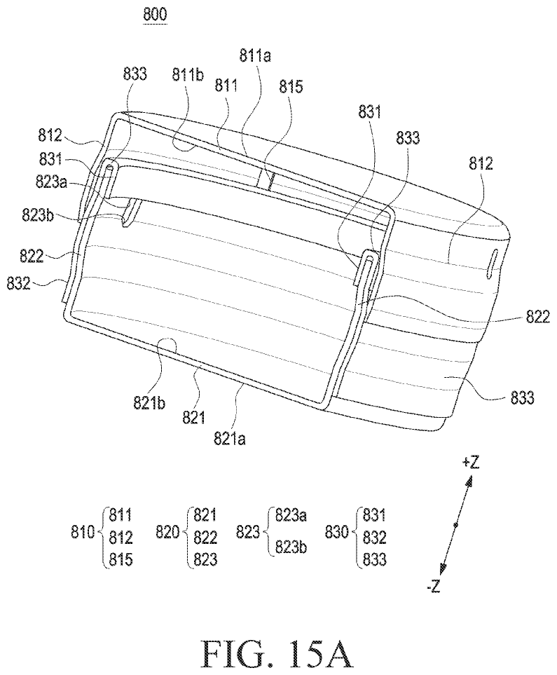

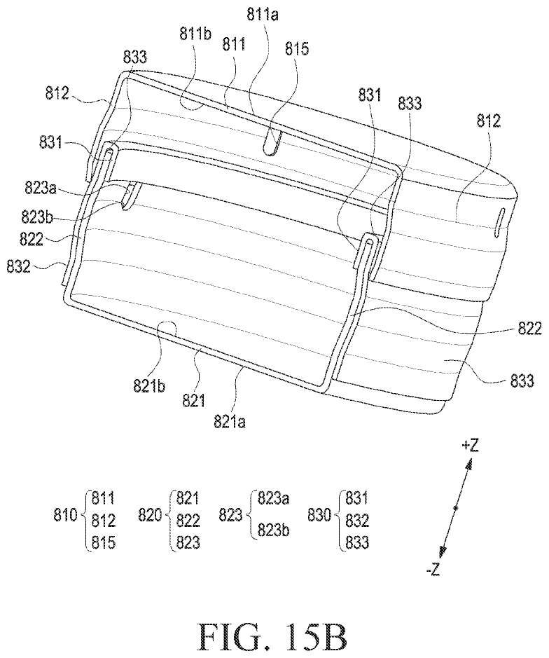

FIG. 15A is a cross-sectional perspective view illustrating gas venting from a battery through a first through hole according to various embodiments. FIG. 15B is a cross-sectional perspective view illustrating gas venting from a battery through a first through hole and/or a vent structure according to various embodiments.

Referring to FIG. 15A and/or FIG. 15B, the battery 800 (e.g., the battery 800 in FIG. 14) may include the first exterior member (e.g., including a cap) 810, the second exterior member (e.g., including a cap) 820, the sealing member (e.g., including a sealing material) 830, and/or the electrode assembly (not shown).

The configuration of the first exterior member 810, the second exterior member 820, and/or the sealing member 830 in FIG. 15A and/or FIG. 15B may be partially or wholly identical to that of the first exterior member 810, the second exterior member 820, and/or the sealing member 830 in FIG. 14. The configuration of the electrode assembly (not shown) in FIG. 15A and/or FIG. 15B may be partially or wholly identical to that of the electrode assembly 440 in FIGS. 6A and 6B.

According to various embodiments, the first exterior member 810 (e.g., the first exterior member 810 in FIG. 14) may include the first planar portion 811 (e.g., the first planar portion 411 in FIGS. 6A and 6B) including an inner surface 811b (e.g., the inner surface 411b in FIGS. 6A and 6B) and the outer surface 811a (e.g., the outer surface 411a in FIGS. 6A and 6B), the first diameter portion 812 (e.g., the first diameter portion 812 in FIG. 14), and/or the first through hole 815.

According to various embodiments, the second exterior member 820 (e.g., the second exterior member 820 of FIG. 14) may include the second planar portion 821 (e.g., the second planar portion 821 in FIG. 14) an inner surface 821b (e.g., the inner surface 421b in FIGS. 6A and 6B), and the outer surface 821a (e.g., the outer surface 821a in FIG. 14), the second diameter portion 822 (e.g., the second diameter portion 422 in FIGS. 6A and 6B), and/or the vent structure 823 (e.g., the vent structure 823 in FIG. 14).

According to various embodiments, the sealing member 830 (e.g., the sealing member 830 of FIG. 14) may include an inner diameter portion 831 (e.g., the inner diameter portion 431 in FIGS. 6A and 6B), an outer diameter portion 832 (e.g., the outer diameter portion 432 in FIGS. 6A and 6B), and/or a connecting portion 833 (e.g., the connecting portion 433 in FIGS. 6A and 6B).

According to various embodiments, the electrode assembly (not shown) (e.g., the electrode assembly 440 in FIGS. 6A and 6B) may be electrically connected to the first exterior member 810 via a first electrode tab (not shown) (e.g., the first electrode tab 441 in FIGS. 6A and 6B) and electrically connected to the second exterior member 820 via a second electrode tab (not shown) (e.g., the second electrode tab 442 in FIGS. 6A and 6B).

According to various embodiments, in an assembled (or manufactured) state of the battery 800, the first exterior member 810 and the second exterior member 820 may be coupled to the sealing member 830. For example, the first exterior member 810 may be coupled to the sealing member 830 such that the inner surface 811a of the first planar portion 811 contacts the connecting portion 833 of the sealing member 830, and the second exterior member 820 may be coupled to the sealing member 830 such that the second diameter portion 822 is inserted between the inner diameter portion 831 and the outer diameter portion 832 of the sealing member 830. The battery 800 may generate gas inside it due to long-term use, deterioration of pole plates of the electrode assembly (not shown) or an electrolyte (not shown), and/or vaporization of the electrolyte caused by an abnormal operation. As a result, the battery 800 may experience a continuous increase in internal pressure, which may cause the first exterior member 810 and/or the second exterior member 820 coupled to the sealing member 830 to be separated.

According to various embodiments, the inclusion of the first through hole 815 and/or the vent structure 823 in the battery 800 may restrict the separation of the first exterior member 810 and/or the second exterior member 820 from the sealing member 830.

According to various embodiments, the battery 800 may be moved in a direction (e.g., in a +Z direction of FIG. 15A) in which the first exterior member 810 recedes from the sealing member 830 due to increased internal pressure caused by the generation of gas within the battery 800.

According to various embodiments, as the first through hole 815 is moved in the direction in which the first exterior member 810 recedes from the sealing member 830, a top portion of the first through hole 815 may be disposed above the top edge region of the sealing member 830 (e.g., disposed biased in the +Z direction of FIG. 15A). In this case, the first through hole 815 may be at least partially open, and the resulting communication between the inside and outside of the battery 800 may allow gas to be vented from the inside of the battery 800 to the outside of the battery 800.

The first through hole 815 may be blocked by a foreign material inside and/or outside of the battery 800 or by the electrode assembly (not shown), and gas may not be vented smoothly from the inside of the battery 800. As a result, the battery 800 may cause the first exterior member 810 and/or the second exterior member 820 to be separated from the sealing member 830.

According to various embodiments, the inclusion of the vent structure 823 in the battery 800 may restrict the separation of the first exterior member 810 and/or the second exterior member 820 from the sealing member 830, even if the first through hole 815 is blocked.

According to various embodiments, the sealing member 830 may have a corrugated shape in an area corresponding to the vent structure 823 of the second exterior member 820. According to an embodiment, the sealing member 830 may have a corrugated shape as at least a portion (e.g., a portion corresponding to the vent structure 823 of the second diameter portion 832) is pushed into an empty space formed by the vent structure 823. According to an embodiment, the sealing member 830 may form a specific gap between the corrugated portion and the first diameter portion 812 of the first exterior member 810.

According to various embodiments, the battery 800 may be moved in the direction in which the first exterior member 810 recedes from the sealing member 830 (e.g., in the +Z direction in FIG. 15B) due to increased internal pressure caused by the generation of gas within the battery 800, as illustrated in FIG. 15B.

According to various embodiments, as the vent structure 823 is moved in the direction in which the first exterior member 810 recedes from the sealing member 830, a deepest portion of the vent structure 823 (e.g., a most −Z direction-biased portion of the second portion 823b of the vent structure 823 in FIG. 15B) may be disposed lower than a bottom edge region of the first diameter portion 812 of the first exterior member 810. For example, the vent structure 823 may be configured to form a gap between the sealing member 830 and the first exterior member 810, when the internal pressure of the battery 800 is equal to or greater than an arbitrary pressure. The arbitrary pressure may be understood as a pressure to which the internal pressure of the battery 800 increases, causing the first exterior member 810 to recede from the sealing member 830. In this case, the specific gap formed between the first exterior member 810 and the sealing member 830 may be opened, thereby allowing communication between the inside and outside of the battery 800. In the case, gas may be vented from the inside of the battery 800 to the outside.

According to various example embodiments of the disclosure, an electronic device (e.g., the electronic device 101 in FIG. 1) may include a housing (e.g., the housing 310 in FIG. 3) and a battery (e.g., the battery 389 in FIG. 5) disposed inside the housing, and the battery may include: a sealing member comprising a sealing material (e.g., the sealing member 430 in FIGS. 6A and 6B) with open top and bottom surfaces, a first exterior member comprising a cap (e.g., the first exterior member 410 in FIGS. 6A and 6B) coupled to the sealing member and configured to cover the top surface of the sealing member, a second exterior member comprising a cap (e.g., the second exterior member 420 in FIGS. 6A and 6B) coupled to the sealing member and configured to cover the bottom surface of the sealing member, an electrode assembly including at least one electrode (e.g., the electrode assembly 440 in FIGS. 6A and 6B) accommodated in the second exterior member, an electrolyte provided in the second exterior member, and a vent structure including a vent (e.g., the vent structure 513 in FIG. 7, the vent structure 634 in FIG. 9, the vent structure 723 in FIG. 11, or the vent structure 823 in FIG. 14) formed in at least one of an edge region of the sealing member, an edge region of the first exterior member, and an edge region of the second exterior member, and configured to communicate between an inside and an outside of the battery.

According to various example embodiments, the vent structure may be configured to form a gap between the sealing member and the first exterior member, based on internal pressure of the battery being equal to or greater than an arbitrary pressure.

According to various example embodiments, the sealing member may include an inner diameter portion (e.g., the inner diameter portion in FIGS. 6A and 6B) and an outer diameter portion (e.g., the outer diameter portion 432 in FIGS. 6A and 6B) having a diameter greater than a diameter of the inner diameter portion, the first exterior member may include a first planar portion (e.g., the first planar portion 411 in FIGS. 6A and 6B) and a first diameter portion (e.g., the first diameter portion 412 in FIGS. 6A and 6B) having a diameter greater than the diameter of the outer diameter portion, and the second exterior member may include a second planar portion (e.g., the second planar portion 421 in FIGS. 6A and 6B) and a second diameter portion (e.g., the second diameter portion 422 in FIGS. 6A and 6B) having a diameter less than the diameter of the outer diameter portion.

According to various example embodiments, the second diameter portion may be disposed between the inner diameter portion and the outer diameter portion.

According to various example embodiments, the vent structure (e.g., the vent structure 513 in FIG. 7) may include a groove recessed from at least a portion of a bottom edge region of the first exterior member (e.g., the first exterior member 510 in FIG. 7) toward a top end of the first exterior member.

According to various example embodiments, the vent structure may include a first portion (e.g., the first portion 513a in FIG. 7) extending with a constant width from the bottom edge region of the first exterior member toward the top end of the first exterior member, and a second portion (e.g., the second portion 513b in FIG. 7) extending with a decreasing width from a top of the first portion toward the top end of the first exterior member.

According to various example embodiments, the vent structure (e.g., the vent structure 634 in FIG. 9) may include a groove recessed from at least a portion of a top edge region of the sealing member (e.g., the sealing member 630 in FIG. 9) toward a bottom end of the sealing member.

According to various example embodiments, the sealing member may include an inner diameter portion (e.g., the inner diameter portion 631 in FIG. 9), an outer diameter portion (e.g., the outer diameter portion 632 in FIG. 9) having a diameter greater than a diameter of the inner diameter portion, and a connecting portion (e.g., the connecting portion 633 in FIG. 9) connecting a top end of the inner diameter portion to a top end of the outer diameter portion, wherein the vent structure may be recessed from a top edge region of the connecting portion toward the outer diameter portion.

According to various example embodiments, the vent structure (e.g., the vent structure 723 in FIG. 11) may include a groove recessed from at least a portion of a top edge region of the second exterior member (e.g., the second exterior member 720 in FIG. 11) toward a bottom of the second exterior member.

According to various example embodiments, the vent structure may include a first portion (e.g., the first portion 723a in FIG. 11) extending with a constant width from the top edge region of the second exterior member toward the bottom of the second exterior member, and a second portion (e.g., the second portion 723b in FIG. 11) extending with a decreasing width from a bottom end of the first portion toward the bottom end of the second exterior member.

According to various example embodiments, the first exterior member (e.g., the first exterior member 710 in FIG. 13) includes a first planar portion (e.g., the first planar portion 711 in FIG. 13), a first diameter portion (e.g., the first diameter portion 712 in FIG. 13) extending from an edge of the first planar portion, and a protrusion member including a protrusion (e.g., the protrusion member 714 in FIG. 13) formed on a portion facing the sealing member (e.g., the sealing member 730 in FIG. 13), of the first diameter portion.

According to various example embodiments, the protrusion member (e.g., the protrusion member 714 in FIG. 13) may correspond to the vent structure (e.g., the vent structure 723 in FIG. 13).

According to various example embodiments, the first diameter portion (e.g., the first diameter portion 712 in FIG. 13) may include a first first diameter portion (e.g., the (1-1)^{th} diameter portion 712-1 in FIG. 13) extending from the edge of the first planar portion and a second first diameter portion (e.g., the (1-2)^{th} diameter portion 712-2 in FIG. 13) extending from the first first diameter portion and having a diameter (e.g., the diameter d2 in FIG. 13) greater than a diameter (e.g., the diameter d1 in FIG. 13) of the first first diameter portion, and the protrusion member (e.g., the protrusion member 714 in FIG. 13) may be formed on the second first diameter portion.

According to various example embodiments, the first exterior member (e.g., the exterior member 810 in FIG. 14) may include a first planar portion (e.g., the first planar portion 811 in FIG. 14), a first diameter portion (e.g., the first diameter portion 812 in FIG. 14) extending from the edge of the first planar portion, and a first through hole (e.g., the first through hole 815 in FIG. 14) penetrating at least a portion of the first diameter portion.

According to various example embodiments, based on an internal pressure of the battery (e.g., the battery 700 in FIG. 11 or the battery 800 in FIG. 14) increasing and the first exterior member (e.g., the first exterior member 510 in FIG. 7, the first exterior member 610 in FIG. 9, the first exterior member 710 in FIG. 11, or the first exterior member 810 in FIG. 14) moving in a direction receding from the sealing member (e.g., the sealing member 530 in FIG. 7, the sealing member 630 in FIG. 9, the sealing member 730 in FIG. 11, or the sealing member 830 in FIG. 14), the vent structure (e.g., the vent structure 513 in FIG. 7, the vent structure 634 in FIG. 9, the vent structure 723 in FIG. 11, or the vent structure 823 in FIG. 14) may form a gap communicating between the inside and outside of the battery.

According to various example embodiments of the disclosure, a wearable electronic device (e.g., the electronic device 101 in FIG. 1 or the electronic device 300 in FIG. 3) may include a housing (e.g., the housing 310 in FIG. 3) including a protrusion (e.g., the protrusion 316 in FIG. 3) and a battery (e.g., the battery 389 in FIG. 5) disposed inside the housing. The battery may include: a sealing member comprising a sealing material (e.g., the sealing member 430 in FIGS. 6A and 6B) with open top and bottom surfaces, a first exterior member comprising a cap (e.g., the first exterior member 410 in FIGS. 6A and 6B) coupled to the sealing member and configured to cover the top surface of the sealing member, a second exterior member comprising a cap (e.g., the second exterior member 420 in FIGS. 6A and 6B) coupled to the sealing member and configured to cover the bottom surface of the sealing member, an electrode assembly including at least one electrode (e.g., the electrode assembly 440 in FIGS. 6A and 6B) accommodated in the second exterior member, an electrolyte provided in the second exterior member, and a vent structure including at least one vent (e.g., the vent structure 513 in FIG. 7, the vent structure 634 in FIG. 9, the vent structure 723 in FIG. 11, or the vent structure 823 in FIG. 14) formed in at least one of an edge region of the sealing member, an edge region of the first exterior member, and an edge region of the second exterior member, and configured to communicate between an inside and an outside of the battery.

According to various example embodiments, the vent structure (e.g., the vent structure 513 in FIG. 7) may include a groove recessed from at least a portion of a bottom edge region of the first exterior member (e.g., the first exterior member 510 in FIG. 7) toward a top of the first exterior member.

According to various example embodiments, the vent structure (e.g., the vent structure 634 in FIG. 9) may include a groove recessed from at least a portion of a top edge region of the sealing member (e.g., the sealing member 630 in FIG. 9) toward a bottom of the sealing member.

According to various example embodiments, the vent structure (e.g., the vent structure 723 in FIG. 11) may include a groove recessed from at least a portion of a top edge region of the second exterior member (e.g., the second exterior member 720 in FIG. 11) toward a bottom of the second exterior member.

According to various example embodiments of the disclosure, a battery (e.g., the battery 389 in FIG. 5) may include: a sealing member comprising a sealing material (e.g., the sealing member 430 in FIGS. 6A and 6B), having open top and bottom surfaces, and including an inner diameter portion (e.g., the inner diameter portion 431 in FIGS. 6A and 6B), an outer diameter portion (e.g., the outer diameter portion 432 in FIGS. 6A and 6B) having a diameter greater than a diameter of the inner diameter portion, and a connecting portion (e.g., the connecting portion 433 in FIGS. 6A and 6B) connecting a top of the inner diameter portion to a top of the outer diameter portion, a first exterior member comprising a cap (e.g., the first exterior member 410 in FIGS. 6A and 6B) coupled to the sealing member, configured to cover the top surface of the sealing member, and including a first planar portion (e.g., the first planar portion 411 in FIGS. 6A and 6B) and a first diameter portion (e.g., the first diameter portion 412 in FIGS. 6A and 6B) extending from an edge of the first planar portion to surround the outer diameter portion, a second exterior member comprising a cap (e.g., the second exterior member 420 in FIGS. 6A and 6B) coupled to the sealing member, configured to cover the bottom surface of the sealing member, and including a second planar portion (e.g., the second planar portion 421 in FIGS. 6A and 6B) and a second diameter portion (e.g., the second diameter portion 422 in FIGS. 6A and 6B) extending from an edge of the second diameter portion located between the inner diameter portion and the outer diameter portion, an electrode assembly (e.g., the electrode assembly 440 in FIGS. 6A and 6B) accommodated in the second exterior member and including a first electrode tab (e.g., the first electrode tab 441 in FIGS. 6A and 6B) electrically connected to the first exterior member and a second electrode tab (e.g., the second electrode tab 442 in FIGS. 6A and 6B) electrically connected to the second exterior member, an electrolyte provided in the second exterior member, and a vent structure comprising a vent (e.g., the vent structure 513 in FIG. 7, the vent structure 634 in FIG. 9, the vent structure 723 in FIG. 11, or the vent structure 823 in FIG. 14) formed in at least one of a top edge region of the sealing member, a bottom edge region of the first exterior member, and an edge region of the second exterior member, and configured to communicate between an inside and an outside of the battery.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a housing; and
a battery disposed inside the housing,
wherein the battery includes:
a sealing member comprising a sealing material and having open top and bottom surfaces;
a first exterior member comprising a cap coupled to the sealing member and configured to cover the top surface of the sealing member;
a second exterior member comprising a cap coupled to the sealing member and configured to cover the bottom surface of the sealing member;
an electrode assembly including at least one electrode accommodated in the second exterior member;
an electrolyte provided in the second exterior member; and
a vent structure including at least one vent formed in at least one of an edge region of the sealing member, an edge region of the first exterior member, and an edge region of the second exterior member, and configured to communicate between an inside and an outside of the battery.

2. The electronic device of claim 1, wherein the vent structure is configured to form a gap between the sealing member and the first exterior member, based on an internal pressure of the battery being equal to or greater than a specified pressure.

3. The electronic device of claim 1, wherein the sealing member includes an inner diameter portion and an outer diameter portion having a diameter greater than a diameter of the inner diameter portion,
wherein the first exterior member includes a first planar portion and a first diameter portion having a diameter greater than the diameter of the outer diameter portion, and
wherein the second exterior member includes a second planar portion and a second diameter portion having a diameter less than the diameter of the outer diameter portion.

4. The electronic device of claim 3, wherein the second diameter portion is disposed between the inner diameter portion and the outer diameter portion.

5. The electronic device of claim 1, wherein the vent structure includes a groove recessed from at least a portion of a bottom edge region of the first exterior member toward a top end of the first exterior member.

6. The electronic device of claim 5, wherein the vent structure includes a first portion extending with a constant width from the bottom edge region of the first exterior member toward the top end of the first exterior member, and a second portion extending with a decreasing width from a top end of the first portion toward the top end of the first exterior member.

7. The electronic device of claim 1, wherein the vent structure includes a groove recessed from at least a portion of a top edge region of the sealing member toward a bottom end of the sealing member.

8. The electronic device of claim 7, wherein the sealing member includes an inner diameter portion, an outer diameter portion having a diameter greater than a diameter of the inner diameter portion, and a connecting portion connecting a top end of the inner diameter portion to a top end of the outer diameter portion, and
wherein the vent structure is recessed from a top edge region of the connecting portion toward the outer diameter portion.

9. The electronic device of claim 1, wherein the vent structure includes a groove recessed from at least a portion of a top edge region of the second exterior member toward a bottom end of the second exterior member.

10. The electronic device of claim 9, wherein the vent structure includes a first portion extending with a constant width from the top edge region of the second exterior member toward the bottom end of the second exterior member, and a second portion extending with a decreasing width from a bottom end of the first portion toward the bottom end of the second exterior member.

11. The electronic device of claim 9, wherein the first exterior member includes a first planar portion, a first diameter portion extending from an edge of the first planar portion, and a protrusion member comprising a protrusion formed on a portion facing the sealing member, of the first diameter portion.

12. The electronic device of claim 11, wherein the protrusion member is located to correspond to the vent structure.

13. The electronic device of claim 11, wherein the first diameter portion includes a first first diameter portion extending from the edge of the first planar portion and a second first diameter portion extending from the first first diameter portion and having a diameter greater than a diameter of the first first diameter portion, and
wherein the protrusion member is formed on the second first diameter portion.

14. The electronic device of claim 9, wherein the first exterior member includes a first planar portion, a first diameter portion extending from the edge of the first planar portion, and a first through hole penetrating at least a portion of the first diameter portion.

15. The electronic device of claim 1, wherein based on an internal pressure of the battery increasing and the first exterior member moving in a direction receding from the sealing member, the vent structure is configured to form a gap for communicating between the inside and outside of the battery.

16. A wearable electronic device comprising:
a housing including a protrusion; and
a battery disposed inside the housing,
wherein the battery includes:
a sealing member comprising a sealing material and having open top and bottom surfaces;
a first exterior member comprising a cap coupled to the sealing member and configured to cover the top surface of the sealing member;
a second exterior member comprising a cap coupled to the sealing member and configured to cover the bottom surface of the sealing member;
an electrode assembly including at least one electrode accommodated in the second exterior member,
an electrolyte provided in the second exterior member; and
a vent structure including at least one vent formed in at least one of an edge region of the sealing member, an edge region of the first exterior member, and an edge region of the second exterior member, and configured to communicate between an inside and an outside of the battery.

17. The wearable electronic device of claim 16, wherein the vent structure includes a groove recessed from at least a portion of a bottom edge region of the first exterior member toward a top of the first exterior member.

18. The wearable electronic device of claim 16, wherein the vent structure includes a groove recessed from at least a portion of a top edge region of the sealing member toward a bottom of the sealing member.

19. The wearable electronic device of claim 16, wherein the vent structure includes a groove recessed from at least a portion of a top edge region of the second exterior member toward a bottom of the second exterior member.

20. A battery comprising:
a sealing member comprising a sealing material, having open top and bottom surfaces and including an inner diameter portion, an outer diameter portion having a diameter greater than a diameter of the inner diameter portion, and a connecting portion connecting a top of the inner diameter portion to a top of the outer diameter portion;
a first exterior member comprising a cap coupled to the sealing member, configured to cover the top surface of the sealing member, and including a first planar portion and a first diameter portion extending from an edge of the first planar portion to surround the outer diameter portion;
a second exterior member comprising a cap coupled to the sealing member, configured to cover the bottom surface of the sealing member, and including a second planar portion and a second diameter portion extending from an edge of the second diameter portion located between the inner diameter portion and the outer diameter portion;
an electrode assembly accommodated in the second exterior member and including a first electrode tab electrically connected to the first exterior member and a second electrode tab electrically connected to the second exterior member;
an electrolyte provided in the second exterior member; and
a vent structure including a vent formed in at least one of a top edge region of the sealing member, a bottom edge region of the first exterior member, and an edge region of the second exterior member, and configured to communicate between an inside and an outside of the battery.
